(19) United States
(12) Patent Application Publication
(10) Pub. No.: US 2012/0252355 A1
(43) Pub. Date: Oct. 4, 2012

(54) APPARATUS AND METHOD FOR HANDING OVER RELAYS

(75) Inventors: Xiaolong Huang, San Diego, CA (US); Rajat Prakash, San Diego, CA (US); Osok Song, San Diego, CA (US); Andrea Garavaglia, Nuremberg (DE); Fatih Ulupinar, San Diego, CA (US)

(73) Assignee: QUALCOMM INCORPORATED, San Diego, CA (US)

(21) Appl. No.: 13/438,701

(22) Filed: Apr. 3, 2012

Related U.S. Application Data
(60) Provisional application No. 61/471,533, filed on Apr. 4, 2011.

(51) Int. Cl. H04W 36/00; H04B 7/14

(52) U.S. Cl. 455/7

(57) ABSTRACT

Methods and apparatuses are provided that include handing over relays in wireless networks. Handover request messages for a relay and related user equipment (UE) can be grouped to lessen signaling requirements for handover. Moreover, identifiers can be communicated in the messages to optimize bearer establishment at a target base station to which the relay and related devices are handed over. Also, handover exception cases can occur, which can be handled by the relay and source and target base stations, such as bearer rejection at the target base station, handover failure for one or more devices or the relay, and/or the like. Further, handover of a relay can occur between base stations that house one or more network gateways for the relay, or where the gateways are centralized and accessible by the source and target base stations, where each scenario can include different exception handling.

### CLAIM OF PRIORITY UNDER 35 U.S.C. §119

The present Application for Patent claims priority to Provisional Application No. 61/471,533, entitled APPARATUS AND METHOD FOR HANDING OVER RELAYS, filed Apr. 4, 2011, assigned to the assignee hereof and hereby expressly incorporated by reference herein.

### BACKGROUND

1. Field

The following description relates generally to wireless network communications, and more particularly to relay nodes and handover thereof.

2. Background

Wireless communication systems are widely deployed to provide various types of communication content such as, for example, voice, data, and so on. Typical wireless communication systems may be multiple-access systems capable of supporting communication with multiple users by sharing available system resources (e.g., bandwidth, transmit power, etc.). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP) (e.g., 3GPP LTE (Long Term Evolution)/LTE-Advanced), ultra mobile broadband (UMB), evolution data optimized (EV-DO), etc.

Generally, wireless multiple-access communication systems may simultaneously support communication for multiple mobile devices. Each mobile device may communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations may be established via single-input single-output (SISO) systems, multiple-input single-output (MISO) systems, multiple-input multiple-output (MIMO) systems, and so forth.

In addition, relays can be used in some wireless communication systems to expand base station coverage, improve communication throughput, and/or the like. For example, relays can be assigned resources from a base station (much like a device), and can assign resources to a device (much like a base station). Upon receiving communications from the base station over the resources assigned by the base station, the relay can transmit the communications to one or more intended devices over resources assigned thereto by the relay, and vice versa. The relay can perform decoding/encoding of signals received before transmitting to the intended device or base station. Relays can operate in: a half duplex mode, where at any given time, the relays receive signals from a base station or transmit to a device, but typically not both; or a full duplex mode where the relay can transmit and receive at the same time (e.g., in the same frequency band).

Relays can handover from one base station to another where the relay can be mobile, where one base station fails and the relay switches to another base station to retransmit communications therefrom, and/or the like. Using existing handover procedures to handover the relays, and corresponding user equipment communicating with the relays, can generate undue signaling load and delay in communications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, the present disclosure describes various aspects in connection with optimizing handover for relays in a wireless network. In one example, handover messages related to devices communicating with a relay can be grouped together (and/or with a request to handover the relay). Similarly, feedback associated with the handovers can be grouped as well. In addition, for example, various aspects are described for communicating among network nodes to minimize interruption to relay and/or corresponding device communication. For example, such aspects can include identifying device bearers at the relay to facilitate continuing routing of packets to the devices following the handover of the relay, sending relay bearer packets to the relay before sending device packets to ensure relevant bearers are first established with the relay before communicating device data, initiating a procedure to create a session in a gateway corresponding to the relay upon receiving a request to create a session from another network node, assigning a temporary address to the relay for communicating in the network, and/or the like. In addition, aspects related to handling of handover exception scenarios are also described.

According to an example, a method for handing over a relay and associated user equipment (UE) is provided. The method includes generating a handover request message for a relay and grouping one or more different handover request messages for UEs communicating with the relay in the handover request message for the relay. The method further includes transmitting the handover request message for the relay to a target donor evolved Node B (eNB).

In another aspect, an apparatus for handing over a relay and associated UE is provided. The apparatus includes at least one processor configured to group one or more different handover request messages for UEs communicating with a relay in a grouped handover request message and transmit the grouped handover request message to a target donor eNB. The apparatus further includes a memory coupled to the at least one processor.

In yet another aspect, an apparatus for handing over a relay and associated UE is provided. The apparatus includes means for generating a grouped handover request message by grouping one or more different handover request messages for UEs communicating with a relay in the grouped handover request message and means for transmitting the grouped handover request message for the relay to a target donor eNB.

Still, in another aspect, a computer-program product for handing over a relay and associated UE is provided including a non-transitory computer-readable medium having code for causing at least one computer to group one or more different handover request messages for UEs communicating with a relay in a grouped handover request message. The computer-readable medium further includes code for causing the at least one computer to transmit the grouped handover request message for the relay to a target donor eNB.

Moreover, in an aspect, an apparatus for handing over a relay and associated UE is provided that includes a group handover requesting component for generating a grouped handover request message by grouping one or more different handover request messages for UEs communicating with a relay in the grouped handover request message. The apparatus further includes a handover requesting component for transmitting the grouped handover request message for the relay to a target donor eNB.

According to another example, a method for handing over a relay and associated UEs is provided including receiving a grouping of different handover request messages related to a plurality of UEs communicating with a relay from a source donor eNB and establishing one or more bearers for the relay for communicating with the plurality of UEs based on the grouping of different handover request messages.

In another aspect, an apparatus for handing over a relay and associated UE is provided. The apparatus includes at least one processor configured to receive a grouping of different handover request messages related to a plurality of UEs communicating with a relay from a source donor eNB and establish one or more bearers for the relay for communicating with the plurality of UEs based on the grouping of different handover request messages. The apparatus further includes a memory coupled to the at least one processor.

In yet another aspect, an apparatus for handing over a relay and associated UE is provided. The apparatus includes means for receiving a grouping of different handover request messages related to a plurality of UEs communicating with a relay from a source donor eNB. The apparatus further includes means for establishing one or more bearers for the relay for communicating with the plurality of UEs based on the grouping of different handover request messages.

Still, in another aspect, a computer-program product for handing over a relay and associated UE is provided including a non-transitory computer-readable medium having code for causing at least one computer to receive a grouping of different handover request messages related to a plurality of UEs communicating with a relay from a source donor eNB. The computer-readable medium further includes code for causing the at least one computer to establish one or more bearers for the relay for communicating with the plurality of UEs based on the grouping of different handover request messages.

Moreover, in an aspect, an apparatus for handing over a relay and associated UE is provided that includes a group handover message receiving component for receiving a grouping of different handover request messages related to a plurality of UEs communicating with a relay from a source donor eNB. The apparatus further includes a bearer establishing component for establishing one or more bearers for the relay for communicating with the plurality of UEs based on the grouping of different handover request messages.

In another example, a method for handing over a relay is provided that includes receiving a create session request from a mobility management entity of a relay related to one or more bearers at the relay during handover. The method further includes initiating a create session procedure in a target packet data network (PDN) gateway for the one or more bearers based at least in part on receiving the create session request.

In another aspect, an apparatus for handing over a relay is provided. The apparatus includes at least one processor configured to receive a create session request from a mobility management entity of a relay related to one or more bearers at the relay during handover and initiate a create session procedure in a target PDN gateway for the one or more bearers based at least in part on the create session request. The apparatus further includes a memory coupled to the at least one processor.

In yet another aspect, an apparatus for handing over a relay is provided. The apparatus includes means for receiving a create session request from a mobility management entity of a relay related to one or more bearers at the relay during handover and means for initiating a create session procedure in a target PDN gateway for the one or more bearers based at least in part on the create session request.

Still, in another aspect, a computer-program product for handing over a relay is provided including a non-transitory computer-readable medium having code for causing at least one computer to receive a create session request from a mobility management entity of a relay related to one or more bearers at the relay during handover. The computer-readable medium further includes code for causing the at least one computer to initiate a create session procedure in a target PDN gateway for the one or more bearers based at least in part on the create session request.

Moreover, in an aspect, an apparatus for handing over a relay is provided that includes a session requesting component for receiving a create session request from a mobility management entity of a relay related to one or more bearers at the relay during handover. The apparatus further includes a session establishing component for initiating a create session procedure in a target PDN gateway for the one or more bearers based at least in part on the create session request.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram of an aspect of a system for handing over a relay among donor evolved Node Bs (eNB).

FIG. 2 is a block diagram of an aspect of a system for performing handover of a relay and related user equipment (UE) from a source donor eNB to a target donor eNB.

FIG. 3 is a block diagram of an aspect of a system for creating session requests within gateways of a target donor eNB in a relay handover procedure.

FIG. 4 is a block diagram of an aspect of a long term evolution (LTE) system in accordance with aspects described herein.

FIGS. 5-7 are block diagrams of an aspect of an example system for successful relay handover where the relay gateways are embedded in the donor eNBs.

FIGS. 8-9 are block diagrams of an aspect of an example system for handing over a relay where handover of some related UEs fail.

FIGS. 10-12 are block diagrams of an aspect of an example system for performing a relay handover with partial UE bearer rejections.

FIGS. 13-14 are block diagrams of an aspect of an example system for performing relay handover where relay gateways are centralized.

FIG. 15 is a flow chart of an aspect of a methodology for communicating grouped handover request messages.

FIG. 16 is a flow chart of an aspect of a methodology for establishing bearers based on received grouped handover request messages.

FIG. 17 is a flow chart of an aspect of a methodology for handling bearer establishment rejections.

FIG. 18 is a flow chart of an aspect of a methodology for handling bearer establishment rejections.

FIG. 19 is a flow chart of an aspect of a methodology for establishing a create session procedure in a gateway for a relay.

FIG. 20 is a block diagram of an aspect of a relay or donor eNB in accordance with aspects described herein.

FIG. 21 is a block diagram of an aspect of a system that communicates grouped handover request messages.

FIG. 22 is a block diagram of an aspect of a system that establishes bearers based on received grouped handover request messages.

FIG. 23 is a block diagram of an aspect of a system that establishes a create session procedure in a gateway for a relay.

FIG. 24 is a block diagram of an aspect of a wireless communication system in accordance with various aspects set forth herein.

FIG. 25 is a schematic block diagram of an aspect of a wireless network environment that can be employed in conjunction with the various systems and methods described herein.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

Described herein are various aspects related to facilitating handover of relays. Relays, for example, can be mobile and wirelessly coupled to base stations and/or other relays. Thus, relays can be handed over among various base stations and/or other relays, similarly to mobile devices in a wireless network. There can be additional considerations, however, in handing over relays based at least in part on other devices served by the relay. In one example, devices served by the relay can be handed over to the base station as well, as part of handing over the relay. In this regard, for example, handover messages corresponding to the devices can be grouped together, as can be feedback relating to whether the devices can be handed over. Moreover, the messages and/or feedback can also be grouped with similar messages or feedback related to handover of the relay. In addition, for example, a target base station can be informed of tunnel identifiers related to device bearers to facilitate continuing routing of packets to the devices following the handover of the relay.

Moreover, the target base station to which the relay is handed over can send relay bearer packets to the relay before sending device bearer packets to ensure relevant bearers are first established with the relay. Furthermore, for example, where a target serving gateway of a relay receives a request to create a session from another network node, the target serving gateway can initiate a procedure to create a session in another gateway corresponding to the relay. In yet another example, since obtaining a network address for the relay can have some latency in the handover procedure, the relay and target base station can utilize a temporary address for communicating with one another, and/or base station can provide an address to the relay using radio signaling or other non-access stratum procedures. Additionally, aspects are described for handling exception cases in the handover, such as where handover of the relay fails, handover of one or more devices under the relay fail, establishment of relay or device bearers are partially rejected, and/or the like.

As used in this application, the terms “component,” “module,” “system” and the like are intended to include a computer-related entity, such as but not limited to hardware, firmware, a combination of hardware and software, software, or software in execution, etc. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, mobile terminal, terminal, communication device, user agent, user device, or user equipment (UE), etc. A wireless terminal may be a cellular telephone, a smart phone, a satellite phone, a cordless telephone, a Session Initiation Protocol (SIP) phone, a wireless local loop (WLL) station, a personal digital assistant (PDA), a handheld device having wireless connection capability, a computing device, a tablet, a smart book, a netbook, or other processing devices connected to a wireless modem, etc. Moreover, various aspects are described herein in connection with a base station. A base station may be utilized for communicating with wireless terminal(s) and may also be referred to as an access point, a Node B, evolved Node B (eNB), or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE/LTE-Advanced and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

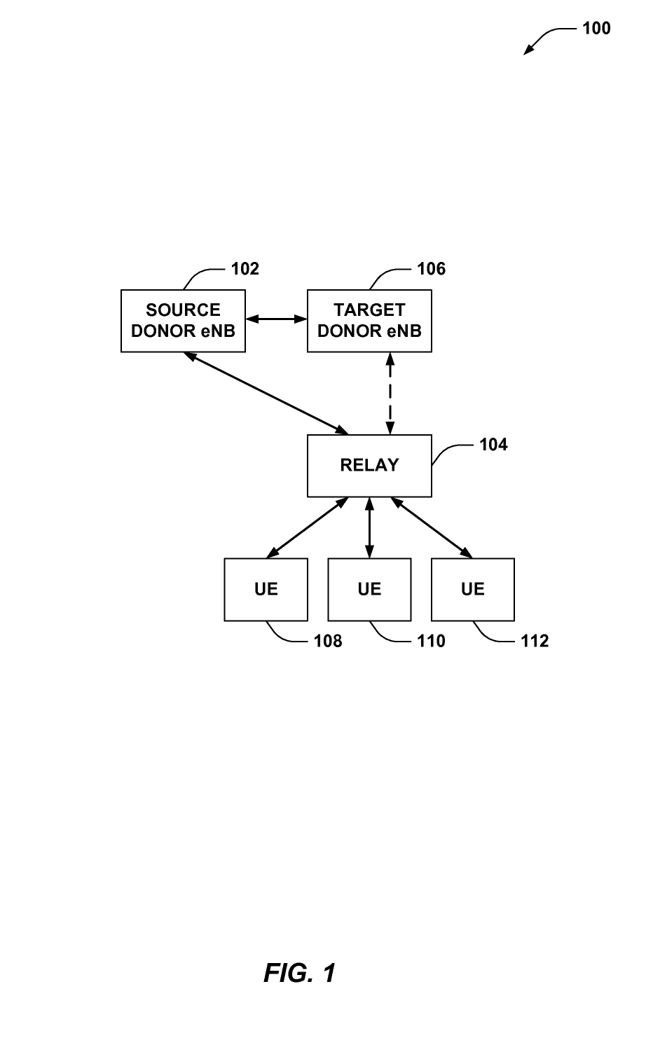

Referring to FIG. 1, a wireless communication system 100 is illustrated that facilitates handing over a relay. System 100 can include a source donor eNB 102 that can provide wireless network access to one or more relays, such as relay 104, UEs, and/or the like. Relay 104 can acquire resources from source donor eNB 102 for communicating therewith. In addition, UEs 108, 110, and 112 can receive wireless network access from relay 104, through source donor eNB 102, by similarly acquiring resources from relay 104. System 100 also includes a target donor eNB 106 to which relay 104 can be handed over. Source donor eNB 102 and target donor eNB 106 can each be substantially any access point, such as a macrocell, femtocell, picocell, or similar base station, a mobile base station, a Wi-Fi hotspot, a portion thereof, and/or the like, and can communicate with one or more core wireless network components, such as gateways, supporting nodes, mobility management entities, and/or the like. Relay 104 can be a mobile relay, in an example, wirelessly coupled to source donor eNB 102, a UE (e.g., communicating in peer-to-peer or ad-hoc mode with UEs 108, 110, and 112, etc.). UEs 108, 110, and 112 can each be a mobile device, modem (or other tethered device), a portion thereof, and/or the like.

In an example, relay 104 can travel throughout a wireless network and can be handed over among donor eNBs (e.g., similarly to a UE). For example, relay 104 can be affixed to and/or within a vehicle, such as a bus, train, boat, car, etc. Thus, relay 104 can handover among donor eNBs (e.g., and/or other relays) as signal quality degrades for a source donor eNB and improves for a target donor eNB at the relay 104. For example, handover can generally refer to a process of moving communications of relay 104 from a source donor eNB to a target donor eNB where the target donor eNB is determined to be a better candidate for serving the relay 104. For example, handover of a relay can include one or more of the following interactions between the relay and one or more donor eNBs: measuring signals received from one or more donor eNBs at a relay, communicating a measurement report from the relay to a source donor eNB that includes information regarding the measurements, determining to handover relay communications to one or more target donor eNBs in the measurement report that is different from the serving donor eNB (also referred to as the source donor eNB) based at least in part on the signal measurements, communicating context information between the source donor eNB and the target donor eNB to prepare the target donor eNB for receiving handover of the relay, instructing the relay to begin communicating with the target donor eNB, etc.

Thus, for example, relay 104 can be communicating with source donor eNB 102 (e.g., transmitting measurement reports thereto or otherwise). Source donor eNB 102 can determine to handover relay 104 to target donor eNB 106, which can be based at least in part on a received measurement report, as described. In another example, relay 104 can initiate its handover to target donor eNB 106 by notifying the source donor eNB 102. Handing over relay 104, however, can also result in handing over UEs that communicate with relay 104, such as UEs 108, 110, and 112, in this example. Source donor eNB 102 can communicate context information regarding the relay 104 and UEs 108, 110, and 112 to target donor eNB 106. Target donor eNB 106 can use the context information to receive handover of the relay 104 and UEs 108, 110, and 112 (e.g., to establish appropriate communication mechanisms, such as one or more network bearers). In an example, source donor eNB 102, target donor eNB 106, and/or one or more core network components (not shown) can perform various optimizations to facilitate handing over relay 104 and corresponding UEs 108, 110, and 112 between source donor eNB 102 and target donor eNB 106.

For example, source donor eNB 102 can group the context information for the various UEs 108, 110, and 112 in a single message, and/or target donor eNB 106 can group corresponding feedback for the context information in a single message to conserve transmission resources. Similarly, donor eNB 102 can group context information for the relay 104 in the single message, and/or target donor eNB 106 can group feedback for the relay 104 context information with that for UEs 108, 110, and 112. For example, the context information can be included in, or otherwise correspond to, handover messages for the UEs 108, 110, and 112, and/or relay 104. Thus, in one example, signaling is reduced at least since UEs 108, 110, and 112 and/or relay 104 need not separately signal handover requests.

Moreover, for example, source donor eNB 102 and target donor eNB 106 can form distinct communication tunnels for relay 104 related traffic and UE 108, 110, and/or 112 related traffic. In this example, target donor eNB 106 can differentiate between relay bearer packets and UE bearer packets received from the source donor eNB 102, which forwards packets received during the handover procedure. Target donor eNB 106 can accordingly transmit the relay 104 bearer packets to relay 104 before transmitting the UE 108, 110, and/or 112 bearer packets to UEs 108, 110, and/or 112 to ensure communications with relay 104 are established for communicating with UEs 108, 110, and/or 112. Moreover, for example, based at least in part on the handover, source donor eNB 102 and/or relay 104 can communicate tunnel identifiers related to UEs 108, 110, and 112 to target donor eNB 106, so that the target donor eNB 106 can forward communications thereto upon handover of relay 104. In one example, the identifiers can be sent as part of the group handover message.

It is to be appreciated that source donor eNB 102 and target donor eNB 106 can include gateway functions for allowing relay 104 to communicate in the wireless network. In another example, the gateway can exist outside of the donor eNBs 102 and 106, and can thus be the same for relay 104 regardless of the donor eNB 102 or 106 to which the relay 104 communicates. Optimizations are possible in both configurations, as described, and in the former example, automatic session creation procedures can be used in the various gateways to minimize signaling and latency in handing over the relay 104. Moreover, at a higher layer, target donor eNB 106 can further optimize handover of relay 104 by assigning relay 104 a temporary address (e.g., internet protocol (IP) address) for communicating with target donor eNB 106 at least until a more permanent address is obtained for the relay 104. Various other optimizations can be additionally or alternatively employed, as described herein.

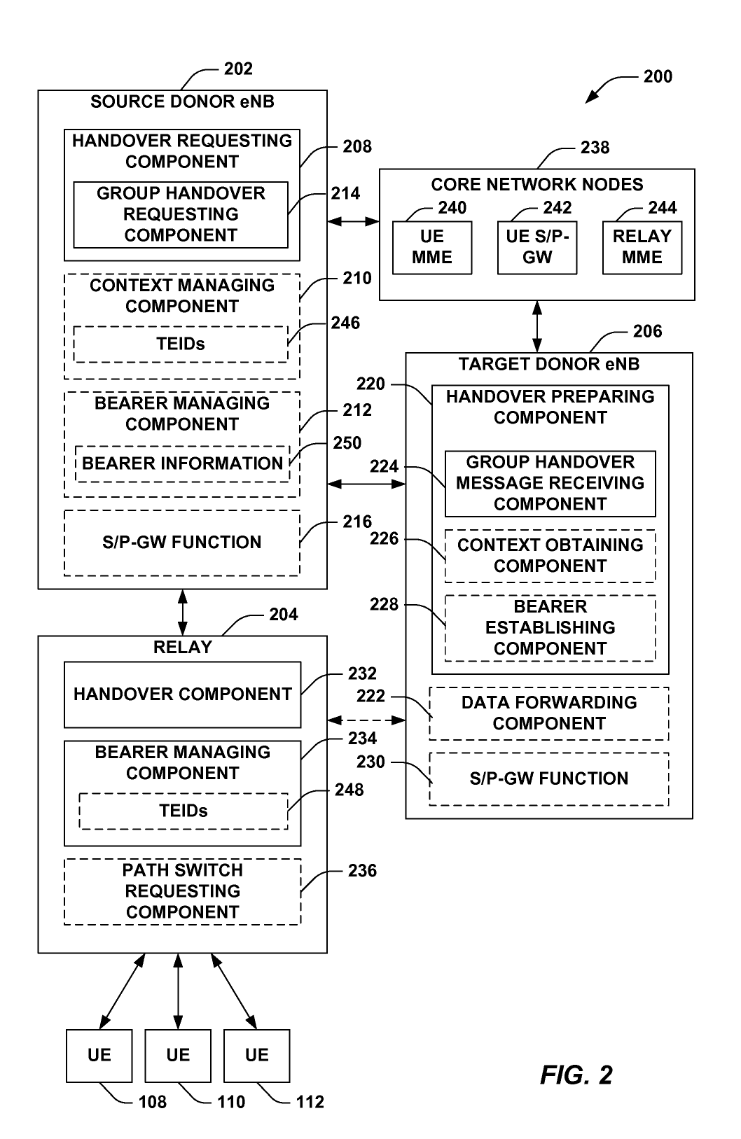

Turning now to FIG. 2, an example wireless communication system 200 that facilitates handing over relays is illustrated. System 200 can include a source donor eNB 202 that provides wireless network access to a relay 204, as described, and a target donor eNB 206 to which relay 204 can be handed over. In one example, source donor eNB 202 and target donor eNB 206 can communicate over a backhaul connection. Moreover, UEs 108, 110, and 112 are shown that communicate with the relay 204 to receive network access. Though three UEs are shown, it is to be appreciated that relay 204 can communicate with substantially any number of UEs.

Source donor eNB 202 can include a handover requesting component 208 for transmitting one or more handover messages related to a relay and/or UEs communicating therewith, an optional context managing component 210 for maintaining contextual information related to the plurality of UEs, relay, and/or one or more other devices, and/or an optional bearer managing component 212 for maintaining one or more bearers with a relay or one or more network nodes. Source donor eNB 202 can also include a serving gateway (S-GW) and/or packet data network (PDN) gateway (P-GW), referred to as S/P-GW, function 216 for allowing the relay 204 to communicate in the wireless network. Handover requesting component 208 can include a group handover requesting component 214 for communicating a handover message including a plurality of handover messages, or related information, of a plurality of UEs communicating with a relay.

Target donor eNB 206 can include a handover preparing component 220 for confirming and processing handover of a relay, and/or an optional data forwarding component 222 that communicates with the relay and a plurality of connected UEs through one or more established communication tunnels. Target donor eNB 206 can also include a S/P-GW function 230 for allowing the relay 204 to communicate in the wireless network, as described. Handover preparing component 220 can include a group handover message receiving component 224 for obtaining a group handover message from a donor eNB including a plurality of handover messages or related information of devices communicating with a relay, an optional context obtaining component 226 for receiving a plurality of contexts related to the plurality of UEs for routing subsequent communications thereto, and/or an optional bearer establishing component 228 for establishing network bearers for the UEs and/or relay to facilitate communicating during and following handover.

Relay 204 can include a handover component 232 for requesting handover to a target donor eNB, a bearer managing component 234 for maintaining one or more bearers established with one or more UEs, and/or an optional path switch requesting component 236 for communicating a path switch request to one or more core network components for one or more UEs based on handover of relay 204.

System 200 also includes core network nodes 238 to which source donor eNB 202 and target donor eNB 206 can communicate. Core network nodes 238 can include a MME for one or more UEs 108, 110, 112 (UE MME 240), a S/P-GW for UEs 108, 110, 112 (UE S/P-GW 242), and a MME for relay 204 (relay MME 244). It is to be appreciated that additional core network nodes can exist and can be employed in communicating with UE MME 240, UE S/P-GW 242, and relay MME 244.

According to an example, as described, source donor eNB 202 can determine to handover relay 204 to target donor eNB 206. In one example, handover component 232 can generate a measurement report of signal qualities of neighboring eNBs, which can specify target donor eNB 206 as having at least a threshold difference in signal quality as compared to source donor eNB 202 or a threshold. Handover requesting component 208 can initiate handover based on this event, for example. In another example, handover component 232 can determine to handover to target donor eNB 206 (e.g., based on similar considerations) and can accordingly notify source donor eNB 202. Handover requesting component 208 can initiate handover based on receiving the notification. In addition, relay 204 can be serving one or more UEs, such as UEs 108, 110, and 112, and thus handover requesting component 208 can initiate handover for the plurality of UEs, including UEs 108, 110, 112, as well since the relay 204 is relaying signals from a respective donor eNB.

In this example, group handover requesting component 214 can generate handover request messages for each of the plurality of UEs 108, 110, and 112, and can group the handover request messages into a single group handover request message. In another example, group handover requesting component 214 can include a handover message for relay 204 in the group handover request message. The handover request messages can include context information regarding the UEs 108, 110, and 112, and/or relay 204, similar to handover request messages in LTE, UMTS, etc. For example, as described further herein, the context information can include information from context managing component 210 regarding the relay 204 and/or UEs 108, 110, and/or 112, such as tunneling endpoint identifiers (TEID) 246, security contexts, and/or other information for establishing network communications for the relay 204 and/or associated UEs 108, 110, and 112.

In this example, group handover message receiving component 224 can obtain the group handover request message, and handover preparing component 220 can attempt to handover UEs 108, 110, and 112, and/or relay 204. For example, attempting to handover the UEs 108, 110, and 112 and/or relay 204 can include ensuring compatibility between UEs 108, 110, and 112 and/or relay 204 with target donor eNB 206, determining whether the UEs 108, 110, and 112 and/or relay 204 are authorized to communicate with target donor eNB 206, determining whether sufficient resources are available to support the UEs 108, 110, and 112 and/or relay 204, or related bearers, at target donor eNB 206, and/or the like. In addition, handover preparing component 220 can generate feedback, such as one or more acknowledgement (ACK), non-acknowledgement (NAK), or similar indicators, etc. regarding whether handover is successful for the UEs 108, 110, and 112 and/or relay 204 at target donor eNB 206. Group handover message receiving component 224 can group the feedback for the UEs 108, 110, and 112 and/or relay 204 into a single group feedback message and can transmit the group feedback message to source donor eNB 202. Group handover requesting component 214 can obtain the group feedback message, for example, and can determine whether handover failed for one or more UEs 108, 110, and 112 or the relay 204 to the target donor eNB 206, which can relate to whether ACK, NAK, or another value is received for a corresponding UE 108, 110, or 112 or relay 204 in the grouped feedback.

It is to be appreciated, in one example, that group handover requesting component 214 can alternatively include the UEs 108, 110, and 112 in the group handover message and can separately request handover of relay 204. Similarly, in this example, group handover message receiving component 224 can generate the group feedback message to include feedback related to the UEs 108, 110, and 112 while generating a different feedback message related to relay 204.

For example, where group handover requesting component 214 determines that handover for the relay 204 failed (e.g., based at least in part on group feedback or feedback regarding the relay 204), group handover requesting component 214 can so notify relay 204 of the failed handover. Handover component 232 can obtain the notification, and relay 204 can attempt to connect to another donor eNB, reconnect to source donor eNB 202 (e.g., using a RRC reestablishment procedure), and/or the like. In this regard, for example, source donor eNB 202 can maintain resources and/or context information related to relay 204 (e.g., and context managing component 210 can maintain context information for UEs 108, 110, and 112 communicating with relay 204) to allow relay 204 to continue communicating with source donor eNB 202 following failed handover without having to reestablish bearers, contexts, etc.

In another example, where group handover requesting component 214 determines that handover of a UE 108, 110, or 112 failed at target donor eNB 206 (e.g., based at least in part on the group feedback), context managing component 210 can send a context release message to the relay 204 relating to the UE 108, 110, or 112 for removing the context. Thus, bearer managing component 234 can send a radio resource release message (such as a radio resource control (RRC) message—e.g., RRCConnectionReconfiguration) to the UE 108, 110, or 112 to release any radio bearers between the relay 204 and the UE. In addition, context managing component 210 (or bearer managing component 234) can similarly send a context release message to a core network node that manages mobility for the UE 108, 110, and 112, such as UE MME 240, to similarly release network resources for the UE 108, 110, or 112. Context managing component 210 can also delete context information stored for the UE 108, 110, or 112, such as a TEID. The UE 108, 110, or 112 can then attempt to connect to another donor eNB or relay.

In one example, relay 204 and UEs 108, 110, 112 can establish one or more radio bearers for communications (referred to herein as UE bearers). For example, bearer managing component 234 can establish the radio bearers for the UEs 108, 110, and 112, and can additionally establish a network bearer, such as an evolved packet system (EPS) bearer, for each UE bearer for routing the communications in a wireless network. For example, bearer managing component 234 can create the network bearer with one or more network components, such as UE MME 240, UE S/P-GW 242, and/or the like, for tunneling communications thereto, via source donor eNB 202, S/P-GW function 216, and/or the like. UE bearers in LTE/LTE-A can be referred to as Uu bearers.

In this example, bearer managing component 234 can encapsulate data sent to the relay 204 from a UE 108, 110, or 112 in a tunneling protocol, which can include modifying the data with a tunneling protocol header. For example, the tunneling protocol header can include one or more identifiers related to the UE 108, 110 or 112, and can be used by the receiving entity (e.g., UE MME 240, UE S/P-GW 242, etc.) to identify the UE to which corresponding communications relate. Similarly, the receiving entity can encapsulate data for communicating back to the UE with a similar identifier. In a specific example, for LTE, the tunneling protocol can include general packet radio services (GPRS) tunneling protocol (GTP), and the identifier can include a TEID.

In addition, for example, relay 204 can establish multiple radio bearers with source donor eNB 202, referred to herein as relay bearers. Such relay bearers in LTE/LTE-A are also referred to as Un bearers. The relay bearers can be associated with one or more UE bearers to facilitate communications thereover. In some examples, the bearer managing component 234 can establish a relay bearer with source donor eNB for each UE bearer (e.g., for QoS UE bearers), one relay bearer for multiple UE bearers (e.g., one best effort relay bearer to handle all best effort UE bearers of UEs 108, 110, and 112), and/or the like, as described further herein. Bearer managing component 212 can receive requests to establish one or more bearers from the relay 204 and can process the requests to initialize a relay bearer therewith.

For given established relay bearers, the S/P-GW function 216, for example, can encapsulate data sent from the relay 204 over the relay bearers in another instance of a tunneling protocol for transmitting to one or more core network components. Similarly, the core network components can encapsulate data sent to the S/P-GW function 216 in the tunneling protocol for associating to the relay 204. For example, the tunneling protocol header can include one or more identifiers related to the relay 204, and can be used by the receiving entity to identify the relay to which corresponding communications relate. In a specific example, for LTE, the tunneling protocol used by the S/P-GW function 216 can also include GTP, and the identifiers can include TEIDs related to the relay 204.

Moreover, in this example, the context managing component 210 can generate and maintain the identifiers for the UEs and/or relay 204 (e.g., TEIDs 246). The relay 204 also stores the TEIDs for the UEs 108, 110, and 112 and/or relay 204. The TEIDs 246 can each be associated to a Uu bearer, and thus S/P-GW function 216 can map

TEIDs to corresponding Un bearers, or related TEIDs thereof. Thus, when a packet is received from the core network, the S/P-GW function 216 can receive the packet based on a TEID of relay 204 indicated in the GTP header related to relay 204, and can forward to the relay 204 over the appropriate Un bearer based on another TEID in the GTP header related to the associated UE.

In this regard, handing over relay 204 and related UEs 108, 110, and 112 of relay 204 to a target donor eNB 206 can also include handing over at least the relay and/or related network bearers, or information related thereto. Moreover, in the example where S/P-GW functions 216 and 230 operate in source donor eNB 202 and target donor eNB 206 (as opposed to being a single S/P-GW for both donor eNBs, as described further herein), the UE bearers can additionally be handed over among S/P-GW functions 216 and 230 when handing over relay 204. For example, this can save from requiring UEs 108, 110 and 112 to reinitialize communications and UE bearers with the relay 204 through the new target donor eNB 206 following handover of the relay 204.

For example, source donor eNB 202 can provide context and bearer information for the UE bearers, relay bearers, and/or related network bearers to the target donor eNB 206. In this example, context managing component 210 can provide target donor eNB 206 with TEIDs 246 related to the network bearers and/or other context information (e.g., security contexts, and/or the like). Context obtaining component 226 can receive the context information for UEs 108, 110, and 112, which can be part of the handover procedure. In one example, handover requesting component 208 can include TEIDs in the handover request message, and context obtaining component 226 can extract the TEIDs for the given UEs 108, 110, and 112 from the handover request message. Similarly, bearer managing component 212 can provide bearer information 250 of the UE bearers to the target donor eNB 206, which can include quality-of-service (QoS) parameters, throughput requirements or history, and/or similar parameters related to the UE bearers. Bearer establishing component 228 can receive the bearer information 250 from source donor eNB 202. In an example, the bearer information 250 can be included in the group handover request message for the UEs and/or including the handover request message for the relay 204, as described above.

Bearer establishing component 228 can attempt to establish the UE, relay, and related network bearers at target donor eNB 206 that are similar to those established by source donor eNB 202 for relay 204 based on the context and bearer information. Establishment of one or more UE or relay bearers may fail for one or more reasons—e.g., target donor eNB 206 does not have sufficient resources to support a QoS bearer, or the target donor eNB 206 is incompatible with a certain bearer type, etc. Where bearer establishing component 228 fails in establishing a relay bearer, for example, handover preparing component 220 can generate a NAK for the relay bearer, and handover requesting component 208 can receive the negative feedback. Handover requesting component 208 can then notify relay 204 of the failed relay bearer establishment in the handover command. Handover component 232 can receive the handover command and failed relay bearer establishment. Bearer managing component 234 can accordingly release UE bearers related to the failed relay bearer, as described above (e.g., using a RRCConnectionReconfiguration or similar message to the corresponding UE, releasing the network bearers at the UE MME 240, etc.). For example, the related UE may not be completely released in this example, since UEs can have multiple bearers established with relay 204.

In another example, establishment of one or more UE bearers at bearer establishing component 228 can fail for one or more reasons (e.g., QoS restrictions, bearer type incompatibility, etc.). In this example, handover preparing component 220 can specify a NAK for the UE bearer in the group handover feedback message. Handover requesting component 208 can receive the feedback message, as described, and can determine the failed UE bearer establishment. In this example, bearer managing component 212 can send a request to deactivate the UE bearer to the relay 204 before handing over the relay 204, and thus the relay 204 can deactivate the bearer, as described previously, before handing over to target donor eNB 206. In another example, the target donor eNB 206 can indicate the NAK in processing the path switch request for the failed UE bearer during handover of relay 204.

Once bearers are established at target donor eNB 206, group handover message receiving component 224 can indicate ACK for the established bearers or related UEs, and handover requesting component 208 can instruct relay 204 to handover to target donor eNB 206, as described. Handover requesting component 208 can additionally forward data received for relay 204 and/or related UEs 108, 110, and 112 to target donor eNB 206 during the handover procedure. For example, this can include handover requesting component 208 forwarding the data over the network bearers established in the core network by target donor eNB 206. In one example, in LTE, the network bearers can correspond to X2-U tunnels between the target donor eNB 206 and relay MME 244, and thus source donor eNB 202 forwards data related to or otherwise received over its X2-U tunnels related to relay 204 to target donor eNB 206 using relay MME 244. Handover preparing component 220 can receive the data. Data forwarding component 222 can forward the data to relay 204 and/or UEs 108, 110, and 112, as described further herein.

Moreover, for example, once handover component 232 connects relay 204 to target donor eNB 206, path switch requesting component 236 can request path switching for the network bearers related to UE bearers of UEs 108, 110, and 112 to pass through target donor eNB 206. In this example, the request is communicated to UE MME 240 or other core network node related to the UEs 108, 110, and 112 to associate TEIDs of the UEs with target donor eNB 206 instead of source donor eNB 202. In one example, the path switch request communicated by path switch requesting component 236 can include the TEIDs 248 of the UE bearers, in addition or alternatively to the group handover request message from source donor eNB 202. Once the path is switched, the source donor eNB 202 no longer receives the data related to relay 204 and corresponding UEs 108, 110, 112, (e.g., and can accordingly send an end marker to target donor eNB 206 indicating the end of forwarded data in one example).

In addition, path switch requesting component 236 can also request path switching for the relay 204 to pass through target donor eNB 206 instead of source donor eNB 202. In this example, path switch requesting component 236 can communicate the request to relay MME 244. In one example, as described further herein, relay MME 244 can send a request to create a session to the S/P-GW function 230, and the S/P-GW function 230 can accordingly initiate a session creation procedure facilitate the path switching. Accordingly, S/P-GW function 230 can receive data related to relay 204 and/or UEs 108, 110, and 112, and can accordingly filter the data into respective network bearers established, as described.

As described, data forwarding component 222 can forward the data from the source donor eNB 202 received during handover using corresponding UE bearers to respective UEs 108, 110, and 112 and relay bearers to relay 204. In one example, data forwarding component 222 can queue data for the UEs 108, 110, and 112 at respective network bearers until all relay 204 data is forwarded. Moreover, once the path is switched, data forwarding component 222 can forward data received in network bearers over the corresponding UE and relay bearers. For example, the data can include TEIDs related to the UEs or UE bearers, and data forwarding component 222 can associate the TEIDs with appropriate UE bearers established by bearer establishing component 228.

In another example, upon receiving a connection request from relay 204, handover preparing component 220 can request network address assignment (e.g., an IP address) for relay 204 from one or more core network components, such as S/P-GW function 230, relay MME 244, etc. This request can have associated delay; however, given that the S1 and X2 protocols (in LTE/LTE-A) are strictly between the target donor eNB 206 and relay 204, having a specific address is not critical. Thus, it is possible to use a temporary address for S1 and X2 messages to avoid latency of normal address assignment.

Thus in one example, handover preparing component 220 can assign a temporary network address to relay 204 using radio control signaling. This can include indicating assignment of the address in one or more messages or otherwise indicating that the relay 204 should use a known temporary address, which can be hardcoded or otherwise configured at relay 204. Handover component 232 can obtain the temporary network address or otherwise an indication to associate with a known temporary network address. In this regard, target donor eNB 206 and relay 204 can communicate using the temporary network address (e.g., to setup an S1 and/or X2 interface in LTE, communicate with an operations, administration, and management (OAM) server, etc.), and can use an indicated logical channel identifier (LCID) or other identifier to filter communications related to relay 204. In another example, handover preparing component 220 can use RRC signaling to assign an address to relay 204, which can conserve time and signaling over existing non-access stratum (NAS) procedures for address assignment.

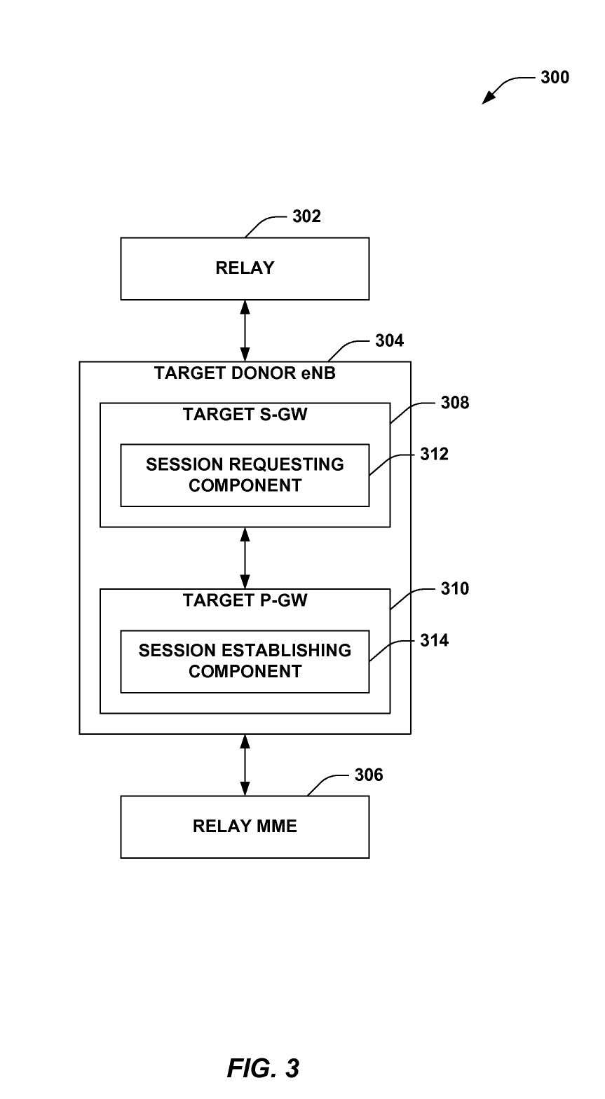

Referring to FIG. 3, an example wireless communication system 300 is illustrated that facilitates establishing a communication session with one or more gateways for a relay during handover. System 300 comprises a relay 302 that is handed over to a target donor eNB 304, as described. System 300 also comprises a relay MME 306 that can authenticate relay 302 with the core network upon connecting to various donor eNBs to facilitate mobility of the relay 302. Moreover, target donor eNB 304 can include a target S-GW 308 and a target P-GW 310 for forwarding relay 302 communications to/from relay MME 306 and/or another core network component. In addition, target S-GW 308 can include a session requesting component 312 for requesting session establishment with a target P-GW for a relay. Target P-GW 310 can include a session establishing component 314 for establishing a communication session related to the relay.

According to an example, relay 302 can be handed over to target donor eNB 304. As described in one example, the target donor eNB 304 can include a S-GW 308 and/or P-GW 310 for the relay 302. Thus, bearers for UEs of relay 302, in this example, are redirected to communicate through target S-GW 308 and P-GW 310, as opposed to S/P-GW of a previous source donor eNB. As part of handover, in this regard, relay MME 306 can transmit a create session request to target S-GW 308 to facilitate establishing network bearers associated with relay bearers that carry UE communications. For example, this can be in response to a path switch request sent thereto, as described. In this example, session requesting component 312 can receive the create session request, and can initiate a session creation procedure with target P-GW 310. Session establishing component 314 can create the session, and notify session requesting component 312. In this regard, relay 302 can communicate with relay MME 306 and/or one or more other core network components via target S-GW 308 and/or target P-GW 310. In particular, communications for the UE bearers of relay 302 can be sent over the established relay bearers.

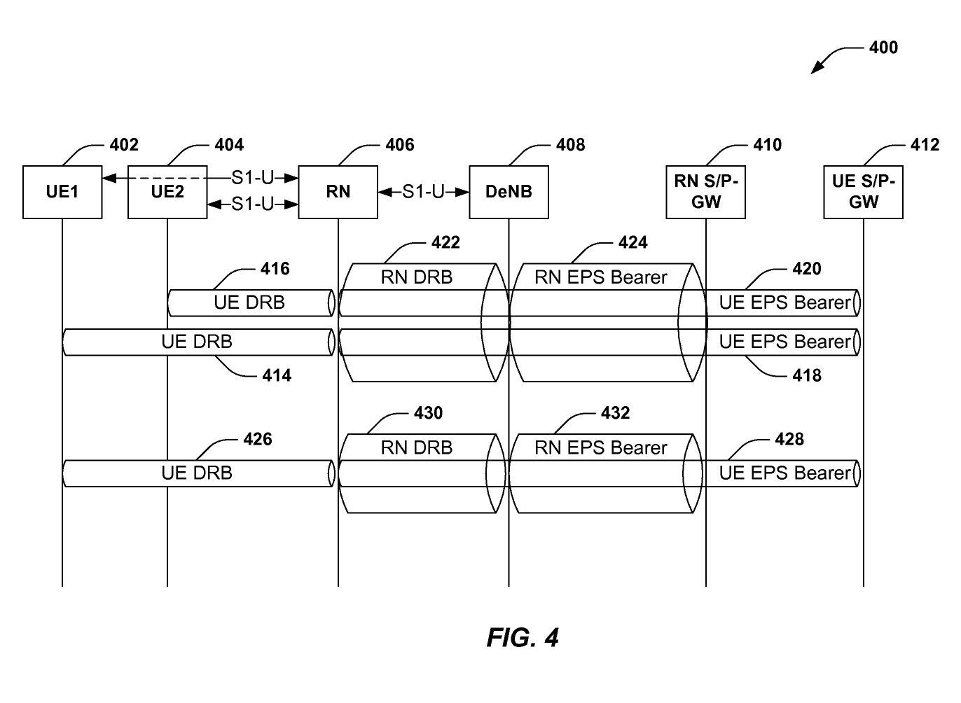

In FIG. 4, an example system 400 is shown illustrating an example LTE/LTE-A architecture in accordance with aspects described herein. System 400 includes UE1 402 and UE2 404 that communicate with a relay eNB (RN) 406, over a S1-U interface, for wireless network access. RN 406 communicates with a DeNB 408, over a S1-U interface, and/or the like, to provide the wireless network access. DeNB 408, in turn, communicates with various core network nodes, which can include a target DeNB (not shown), a RN serving gateway (S-GW) or packet data network (PDN) gateway (P-GW), collectively referred to as a RN S/P-GW 410, as well as one or more UE S/P-GW 412.

UE1 402 and UE2 404 can respectively establish dedicated radio bearers (DRB) 414 and 416 with RN 406. These DRBs 414 and 416, also referred to herein as Uu bearers, can be for BE traffic. Thus, RN 406 establishes a single RN DRB 422 with DeNB 408 to handle the BE traffic for UE DRBs 414 and 416. This RN DRB 422 is also referred to herein as a Un bearer. DeNB 408 can accordingly establish a RN EPS bearer 424 with RN S/P-GW 410 related to RN DRB 422 for communicating data received over the RN DRB 422 in the core network, and also for communicating network data related to RN 406 received in the RN EPS bearer 424 over the RN DRB 422. For example, DeNB 408 can associate an identifier with the RN EPS bearer 424 to identify RN EPS bearer 424 in the core network, such as a TEID. In another example, DeNB 408 can encapsulate communications from the RN 406 in a tunneling protocol including a TEID in a header related to RN 406. Thus, for example, core network communications related to RN EPS bearer 424 can be communicated among DeNB 408 and various nodes, such as RN S/P-GW 410, UE S/P-GW 412, etc. using the tunneling protocol (e.g., GTP) with a header that specifies the TEID for routing the communications.

In another example, RN 406 can establish UE EPS bearers 418 and 420 for UE DRBs 414 and 416, respectively, with UE S/P-GW 412. Thus, data received from the core network at RN 406 over UE EPS bearer 418 can be sent to UE1 402 over UE DRB 414, and data received at RN 406 over UE EPS bearer 420 can be sent to UE2 404 over UE DRB 416. In any case, the single RN DRB 422 and related RN EPS bearer 424 are used to handle BE data related to UE DRBs 414 and 416 and UE EPS bearers 418 and 420. Thus, UE1 402 and UE2 404 traffic received over UE DRBs 414 and 416 are sent over RN DRB 422 to DeNB 408. RN 406 can similarly encapsulate UE1 402 or UE2 404 communications in a GTP with a TEID to identify the related UE. In any case, RN S/P-GW 410 receives the traffic from DeNB 408 and removes the tunneling protocol header, and can forward on traffic over respective UE EPS bearers 418 and 420. UE S/P-GW 412 can also remove tunneling protocol header information from the traffic and determine a related UE.

Similarly, UE S/P-GW 412 can package data intended for UE1 402 or UE2 404 in a GTP with a TEID identifying UE1 402 or UE2 404. RN S/P-GW 410 can further package data received over the UE EPS bearers 418 and 420 from UE S/P-GW 412 with a tunneling protocol header related to RN 406, and can communicate the data to DeNB 408. DeNB identifies the RN 406 based on the header and forwards the data to RN 406, which can forward data to UE1 402 and/or UE2 404 over respective DRB 414 or 416. In one example described above, DeNB 408 can utilize the TEID of RN 406 to identify upstream or downstream packets related thereto.

In addition, UE1 402 is shown as having a guaranteed bit rate (GBR) (or QoS) bearer with RN 406 as well. UE DRB 426 is established with RN 406 as a GBR bearer. RN 406 can establish a dedicated RN DRB 430 with DeNB 408 to handle traffic received over UE DRB 426. DeNB 408 establishes a RN EPS bearer 432 with RN S/P-GW 410 for RN DRB 430, as described above, and similarly, RN 406 establishes a UE EPS bearer 428 with UE S/P-GW 412 for UE DRB 426. UE S/P-GW 412 can similarly package data intended for UE1 402 in a GTP with a TEID identifying UE1 402. RN S/P-GW 410 can further package data received over the UE EPS bearer 428 from UE S/P-GW 412 with a tunneling protocol header related to RN 406, and can communicate the data to DeNB 408. DeNB identifies the RN 406 based on the header and forwards the data to RN 406, which can forward data to UE1 402 over DRB 426.

Illustrated is one example architecture; as described herein, the RN S/P-GW 410 can operate in the DeNB 408, which can cause DeNB 408 to handover the RN EPS bearers 424 and 432, and thus related UE EPS bearers 418, 420, and 428, to a target DeNB during handover of RN 406.

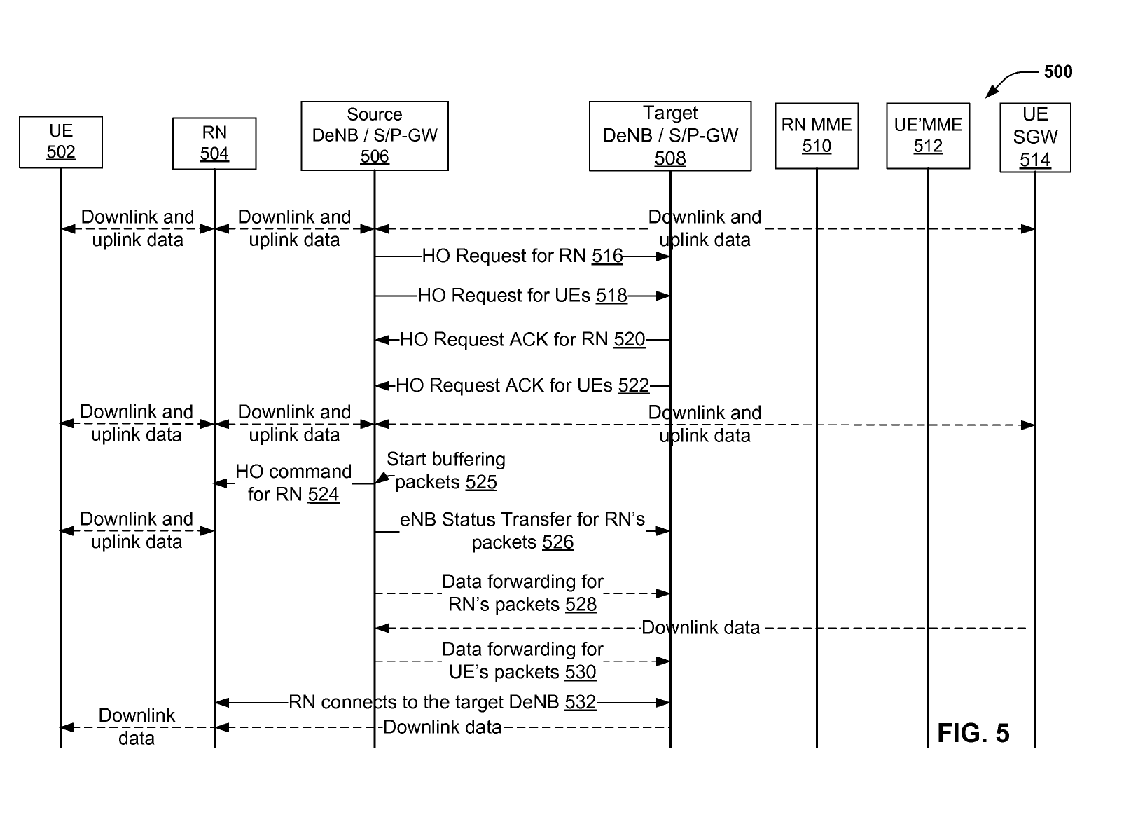

FIGS. 5-7 illustrate an example system 500 of successful relay handover where the relay S/P-GW is embedded in the donor eNBs (DeNB). For example, system 500 includes a UE 502 that communicates with a relay (RN) 504 for access to a wireless network. RN 504 communicates with a source DeNB/S/P-GW 506 (referred to herein as source DeNB 506) and can be handed over to a target DeNB/S/P-GW 508 (referred to herein as target DeNB 508). Moreover, the DeNBs 506 and 508 can communicate with a RN MME 510, a UE MME 512, and a UE S-GW 514, as described previously. An X2 RN handover with embedded RN S/P-GW in the DeNB can include the depicted steps in LTE. The source DeNB 506 sends an X2 Handover Request message 516 to the target DeNB 508 for RN 504. This message creates the RN 504 context in the target DeNB 508, including information about the bearers, and the security context. The target DeNB 508 sends an X2 Handover Request ACK message 520 to the source DeNB 506 for RN 504.

In addition, the source DeNB 506 sends an X2 Handover Request message 518 to the target DeNB 508 for RN UEs, such as UE 502. This Handover Request message 518 can group handover information of all RN UEs. The target DeNB 508 sends an X2 Handover Request ACK message 522 to the source DeNB 506 for RN UEs. It is to be appreciated that where UE MME 512 is not directly accessible by source DeNB 506, source DeNB 506 can instead send a S1 Handover Request message 518, and receive a S1 Handover Request ACK message 522. In either case, an EPS Bearer Setup Result, which can be included in the X2 Handover Request ACK message 522, includes a list of addresses and TEIDs allocated at the target DeNB 508 for downlink traffic on S1-U reference and addresses and TEIDs for receiving forwarded UE S1-U data. In one example, Handover Request Messages 516 and 518 can be the same message, and/or Handover Request ACK messages 520 and 522 can be the same message, as described.

The source DeNB 506 sends the HO command 524 to RN 504. In addition, the source DeNB 506 can start buffering packets at 525 received during the handover procedure for subsequent forwarding to target donor eNB 508. The source DeNB 506 sends an eNB Status Transfer for all RN packets 526. For example, this message can transfer outstanding packets (e.g., received in downlink/uplink data shown in FIG. 5) from source donor eNB 506 to target donor eNB 508. Moreover, in one example, the source DeNB 506 can forward UE 502 downlink data packets to the target DeNB 508 at 528 and 530 (e.g., depending on when downlink data is received for RN 504 or related UEs). RN 504 subsequently connects to the target DeNB 508 at 532.

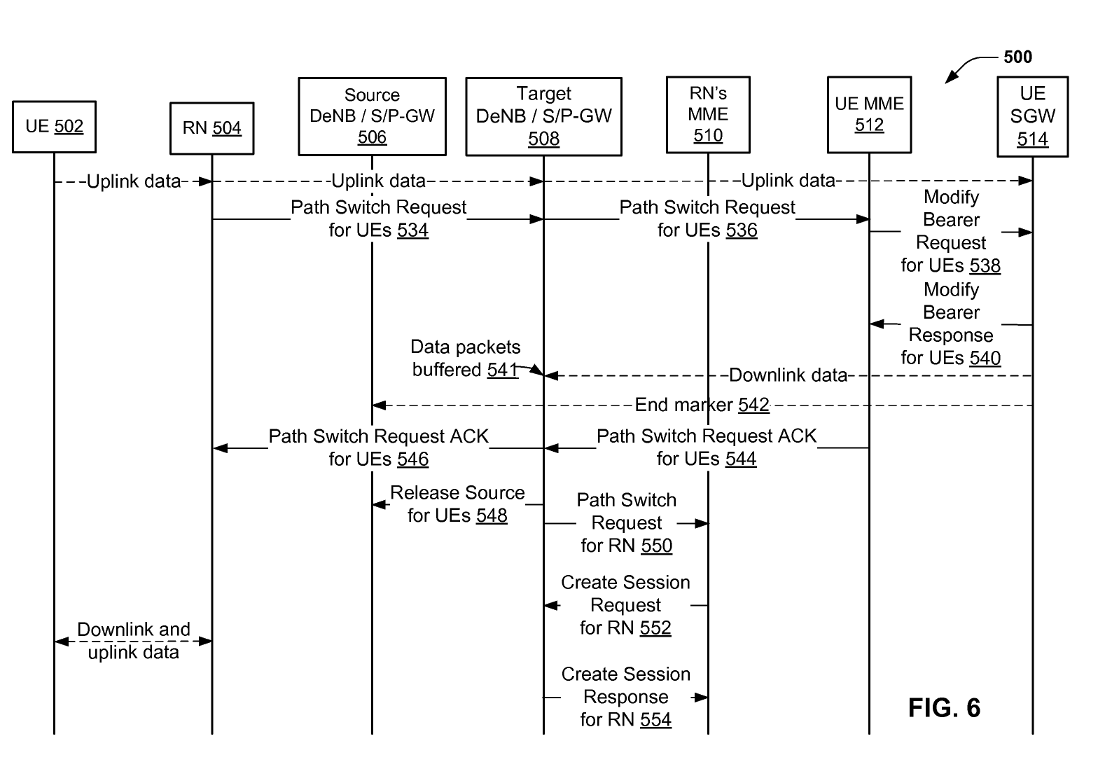

The system 500 continues in FIG. 6, and the RN 504 sends a Path Switch Request message 534 to UE MME 512 for UEs, including UE 502. When the message 534 reaches the target DeNB 508, the target DeNB 508 can obtain the enclosed downlink GTP TEIDs for UE bearers, and can forward the Path Switch Request message 536 to UE MME 512. UE MME 512 sends a Modify Bearer Request 538 with target DeNB 508 address and downlink GTP TEIDs for UE bearers to UE S-GW 514.

UE S-GW 514 can start sending downlink packets to the target DeNB 508 using the newly received address and TEIDs. A Modify Bearer Response message 540 is sent back to UE MME 512. Moreover, target donor eNB 508 can begin buffering packets at 541 so it can first forward data buffered at source DeNB 506 related to relay 504 before data received from UE S-GW 514. UE S-GW 514 sends an end marker 542 to the source DeNB 506 to indicate the end of data to be received for RN 504. UE MME 512 sends a Path Switch Response message (Path Switch Request ACK 544) to target DeNB 508, which forwards the message 546 to the RN 504. The target DeNB 508 sends a Release Source message 548 to the source DeNB 506 to indicate the handover success for all UEs of the RN 504, including UE 502.

The target DeNB 508 also sends a Path Switch Request message 550 to RN MME 510 to switch the path for RN 504. RN MME 510 sends a Create Session Request 552 to the RN S-GW, at target DeNB 508, with traffic flow templates (TFT) for filtering UE packets, such as UE 502. RN target S-GW function, at target DeNB 508, initiates a session creation procedure with the RN target P-GW function, also at target DeNB 508. RN S-GW at target DeNB 508 starts to filter downlink UE packets into RN 504 bearers. A Create Session Response message 554 is sent back to RN MME 510. The target DeNB 508 can queue the packets that come from UE S-GW 514 before it sends out all forwarded RNs packets, as described.

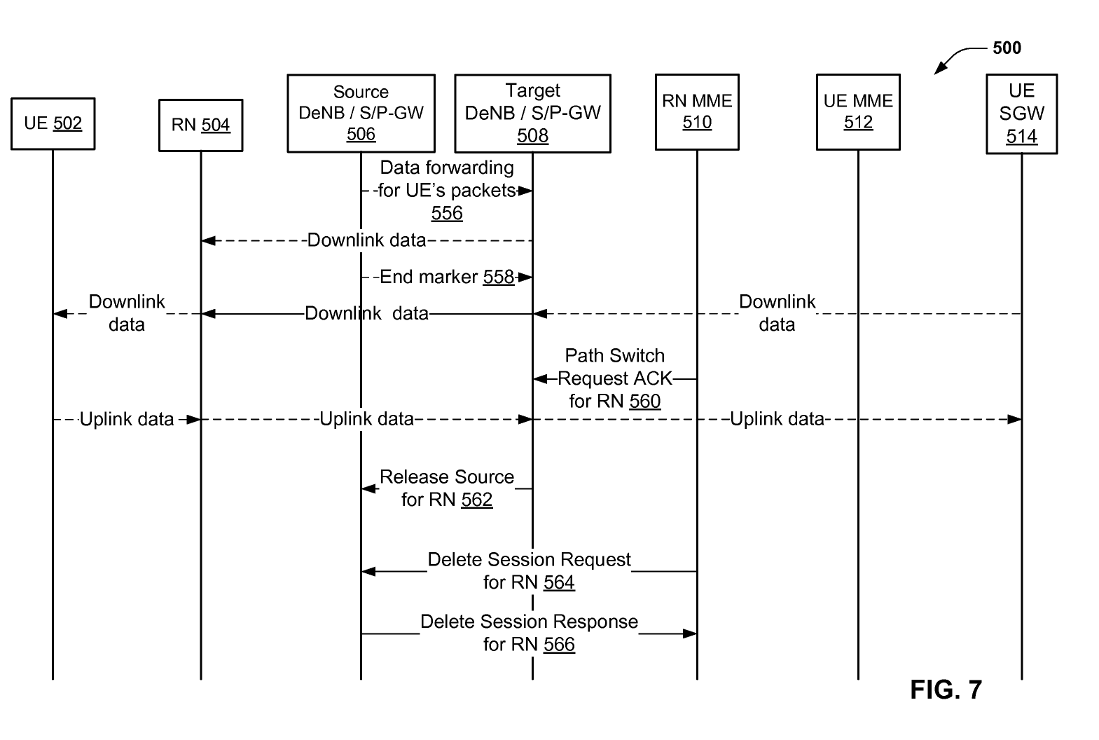

Continuing in FIG. 7, the source DeNB 506 forwards UE packets 556, and sends an End Marker 558 to the target DeNB 508 to indicate its last forwarded RN packets. The target DeNB 508 can now send out UE packets that come from UE S-GW 514, as described. RN MME 510 sends a Path Switch Response message (Path Switch Request ACK 560) to the target DeNB 508. The target DeNB 508 can send uplink data, as shown. By sending Release Resource 562, the target DeNB 508 informs success of the handover to source DeNB 506 and triggers the release of resources. When a timer has expired after sending the Create Session Request 552 or receiving the Create Session Response message 554, RN MME 510 releases the bearer(s) in the RN source S-GW, in source DeNB 506, by sending a Delete Session Request message 564, which is acknowledged by the RN source S-GW, at source DeNB 506, in a Delete Session Response 566.

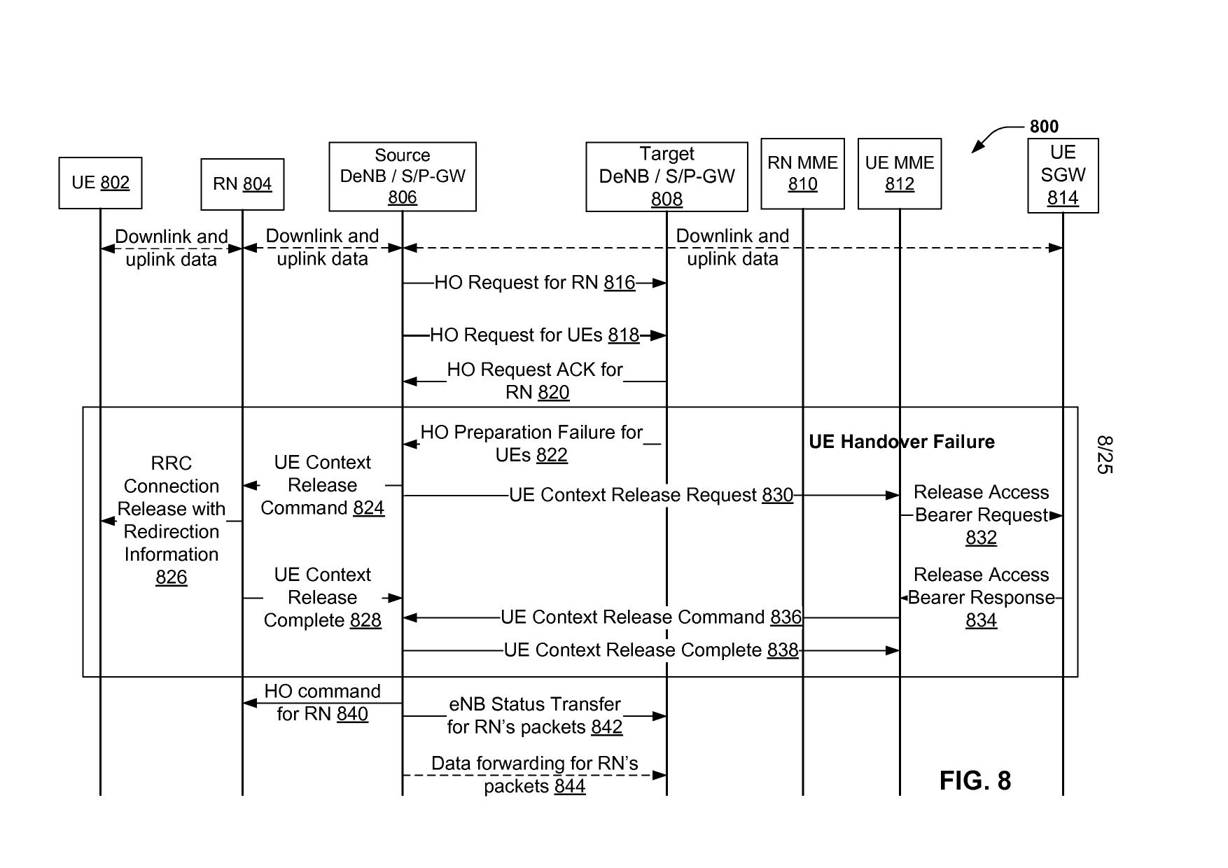

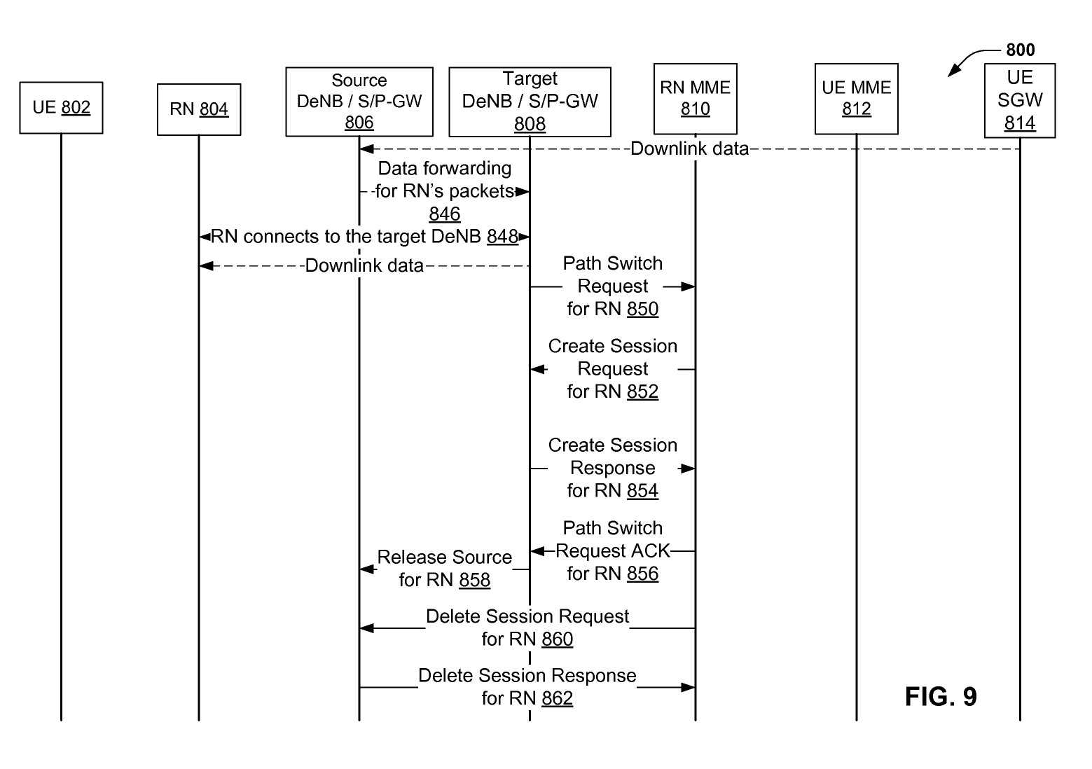

Handover exceptions can occur in this system 500, some of which are described further herein. For example, if handover of RN 504 fails, no further handover routines need to be carried out. The RN 504 may connect to another DeNB by using the attach procedure. If the RN 504 decides to reconnect to the original DeNB 506, it can use the RRC reestablishment procedure before the DeNB 506 removes the RN 504 and UE (e.g., UE 502) context, as described. In another example—e.g., due to admission control reasons—some UEs, such as UE 502, may not be accepted by the target DeNB 508. When the source DeNB 506 receives handover failure messages for some UEs from the target DeNB 508, the source DeNB 506 can send a UE context release command to the RN 504 on behalf of UE MME 512, so that the RN 504 can send a RRC release message to the rejected UE 502. As a result, the source DeNB 506 can send a UE context release request to UE MME 512 to remove the UE 502 context at UE MME 512. This is further shown in FIGS. 8-9 below.

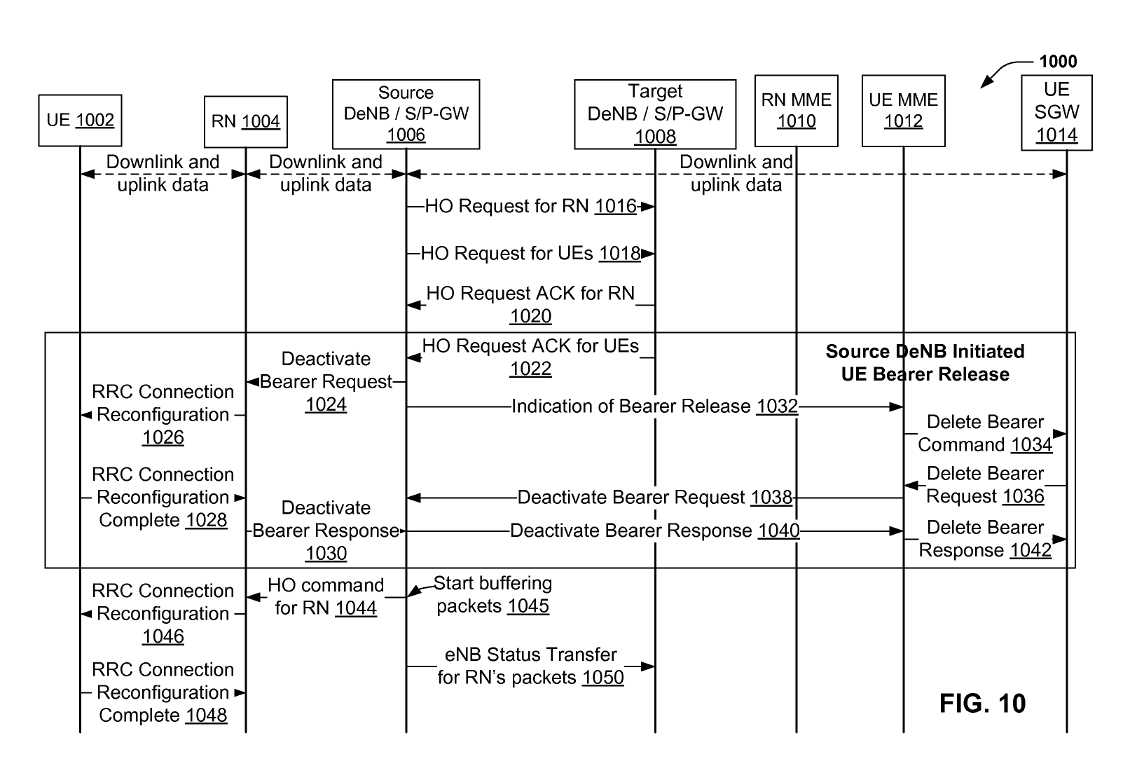

In other exceptions, some UE bearers may not be accepted by the target DeNB 508 (e.g., due to QoS reasons), as described. The RN 504 is informed about the rejected RN bearers from the HO command 524 for RN 504. Since it is not necessary that all bearers of a UE, such as UE 502, belong to a single RN bearer and it is not necessary that all RN bearers associated with a UE are rejected, the RN 504 may not release a UE 502 entirely. Rather, for example, the RN 504 may release the UE radio bearers carried by the rejected RN radio bearers by sending an RRCConnectionReconfiguration message to the UE 502 for the specific UE radio bearers. If the RN 504 decides to release some UE bearers, the RN 504 can send the indication of bearer release of those UE bearers to UE MME 512 as well after it connects to the target DeNB 508, as shown below in FIGS. 10-12.

In addition, for example, UE bearers of a particular UE may be rejected in other exceptions. In this example, when the source DeNB 506 receives HO request ACK for UEs 522 and discovers some UE bearers, such as UE 502, are rejected, the source DeNB 506 can send a Deactivate Bearer Request message to the RN 504 on behalf of UE MME 512. In some examples, the Deactivate Bearer Request message can be sent before the HO command message 524. When the RN 504 receives this message, RN 504 can release the UE radio bearers by sending an RRCConnectionReconfiguration message to the UE, such as UE 502. As a result, the source DeNB 506 can send the indication of bearer release to UE MME 512. In another example, when the target DeNB 506 sends the Path Switch Request message 536 to UE MME 512, the message can exclude those rejected UE bearers. In the Path Switch Request ACK message 546, the UE MME 512 sends back to the RN 504, the message can indicate those rejected UE bearers. The RN 504 can subsequently delete the rejected UE bearers. This exception is also shown in FIGS. 10-12.

In FIGS. 8-9, an example system 800 is shown for handing over a relay where handover of some related UEs fail. For example, system 800 includes a UE 802 that communicates with a relay (RN) 804 for access to a wireless network. RN 804 communicates with a source DeNB/S/P-GW 806 (referred to herein as source DeNB 806) and can be handed over to a target DeNB/S/P-GW 808 (referred to herein as target DeNB 808). Moreover, the DeNBs 806 and 808 can communicate with a RN MME 810, a UE MME 812, and a UE S-GW 814, as described previously. The RN 804 HO procedure with partial UE HO preparation failures can include the following steps.

The source DeNB 806 sends an X2 Handover Request message 816 to the target DeNB 808 for RN 804. This message creates the RN context in the target DeNB 808, including information about the bearers, and the security context. The target DeNB 808 sends an X2 Handover Request ACK message 820 to the source DeNB 806 for RN 804. The source DeNB 806 sends an X2 Handover Request message 818 to the target DeNB 806 for RN UEs, including UE 802. The target DeNB 808, in this example, sends an X2 Handover Preparation Failure message 822 to source DeNB 806 indicating at least some RN UEs for which bearer establishment failed at target DeNB 808. In one example, Handover Request Messages 516 and 518 can be the same message, and/or Handover Request ACK message 520 and Handover Preparation Failure message 822 can be the same message, as described.

The source DeNB 806 sends an S1 UE Context Release Command message 824 on behalf of UE MME 812. After receiving the UE Context Release Command message 824, the RN 804 then sends a RRC Connection Release message 826 to the corresponding UE 802 with redirection information so that the UE 802 can attach to a different eNB. The RN 804 replies to the source DeNB 806 with a UE Context Release Complete message 828. In addition, the source DeNB 806 sends to the UE MME 812 a UE Context Release Request message 830. UE MME 812 releases UE EPS bearers with UE S/P-GW 814 by transmitting a Release Access Bearer Request 832 thereto, and receiving a Release Access Bearer Response 834 therefrom. UE MME 812 then replies to the source DeNB 806 with a UE Context Release Command message 836. Since the source DeNB has autonomously release the UE with the RN in Step 3, the source DeNB sends a UE Context Release Complete message 838 to UE MME to handle the failed handover of the UE bearer(s). Moreover, the source DeNB 806 sends the handover (HO) command to RN 804 at 840. The source DeNB 806 subsequently sends an eNB Status Transfer for all RN packets 842 to target DeNB 808, and source DeNB 806 can forward RN 804 packets to target DeNB 808 at 844.

Continuing in FIG. 9, source DeNB 806 can forward EN 804 packets to target DeNB 808 at 846 as well (e.g., depending on when packets come in). RN 804 connects to the target DeNB 808 at 848. The target DeNB 808 sends a Path Switch Request message 850 to RN MME 810 for RN 804. RN MME 810 sends a Create Session Request 852 to the RN S-GW, within target DeNB 808, with TFTs that should be used for filtering UE packets. RN target S-GW function, within target DeNB 808, initiates a session creation procedure with the RN target P-GW function inside the target DeNB 808. A Create Session Response message 854 is sent back to RN MME 810. RN MME 810 sends a Path Switch Request ACK message 856 to the target DeNB 808. The target DeNB 808 can send uplink data, as described. By sending Release Resource 858, the target DeNB 808 informs success of the handover to source DeNB 806 and triggers the release of resources. When a timer has expired after sending the Create Session Request 852 or receiving the Create Session Response message 854, RN MME 810 releases the bearer(s) in the RN source S-GW, within source DeNB 806 by sending a Delete Session Request message 860 thereto, which is acknowledged by the RN source S-GW within DeNB 806 via a Delete Session Response 862 therefrom.

Referring to FIGS. 10-12, a system 1000 for performing a relay handover with partial UE bearer rejections is illustrated. For example, system 1000 includes a UE 1002 that communicates with a relay (RN) 1004 for access to a wireless network. RN 1004 communicates with a source DeNB/S/P-GW 1006 (referred to herein as source DeNB 1006) and can be handed over to a target DeNB/S/P-GW 1008 (referred to herein as target DeNB 1008). Moreover, the DeNBs 1006 and 1008 can communicate with a RN MME 1010, a UE MME 1012, and a UE S-GW 1014, as described previously. An X2 RN handover with embedded RN S/P-GW in the DeNB can include the depicted steps in LTE/LTE-A with partial UE bearer rejections. The source DeNB 1006 sends an X2 Handover Request message 1016 to the target DeNB 1008 for RN 1004. This message creates the RN 1004 context in the target DeNB 1008, including information about the bearers, and the security context. The target DeNB 1008 sends an X2 Handover Request ACK message 1020 to the source DeNB 1006 for RN 1004.

In addition, the source DeNB 1006 sends an X2 Handover Request message 1018 to the target DeNB 1008 for RN UEs, such as UE 1002. This Handover Request message 1018 can group handover information of all RN UEs. The target DeNB 1008 sends an X2 Handover Request ACK message 1022 to the source DeNB 1006 for RN UEs. An EPS Bearer Setup Result, which can be included in the X2 Handover Request ACK message 1022, includes a list of rejected UE and/or relay bearers (e.g., indicated with a NAK, as described) and/or addresses and TEIDs allocated at the target DeNB 1008 for downlink traffic on S1-U reference and addresses and TEIDs for receiving forwarded UE S1-U data. In one example, Handover Request Messages 1016 and 1018 can be the same message, and/or Handover Request ACK messages 1020 and 1022 can be the same message, as described.

The source DeNB 1006 sends a deactivate bearer request 1024 to the RN 1004 to cause the RN 1004 to release one or more UE bearers for which establishment is rejected. The RN 1004 then sends a RRC Connection Reconfiguration message 1026 to its UE 1002 to delete one or more UE bearers. Since the UE radio bearer release procedure is originated from the RN 1004, it cannot signal UE EPS bearer context release. UEs, such as UE 1002, can delete UE EPS bearer context based on the deleted UE radio bearers. The UE 1002 sends back a RRC Connection Reconfiguration Complete message 1028 to the RN 1004. The RN 1004 subsequently sends the Deactivate Bearer Response message 1030 to the source DeNB 1006.

In addition, the source DeNB 1006 sends an Indication of Bearer Release message 1032 to UE MME 1012, which triggers the UE MME 1012 to delete UE EPS bearers with UE S/P-GW 1014. This can include transmitting a Delete Bearer Command 1034 to the UE S-GW 1014, and receiving a Delete Bearer Response 1036 therefrom. UE MME 1012 can then send a Deactivate Bearer Request message 1038 to the source DeNB 1006, which will be absorbed by the source DeNB 1006. The source DeNB sends back the Deactivate Bearer Response message 1040 to UE MME 1012, which can forward a Delete Bearer Response 1042 to UE S-GW 1014.

Source DeNB 1006 sends the HO command 1044 to RN 1004, which can include a list of rejected RN bearers. In addition, the source DeNB 1006 can start buffering packets at 1045 received during the handover procedure for subsequent forwarding to target donor eNB 1008. In this regard, RN 1004 can release the UE 1002 radio bearers that are carried by the released RN radio bearers by sending an RRCConnectionReconfiguration message 1046 to the UE 1002 and receiving a RRCConnectionReconfigurationComplete message 1048. The source DeNB 1006 sends an eNB Status Transfer for all RN packets 1050. For example, this message can transfer outstanding packets (e.g., received in downlink/uplink data shown in FIG. 10) from source donor eNB 1006 to target donor eNB 1008.

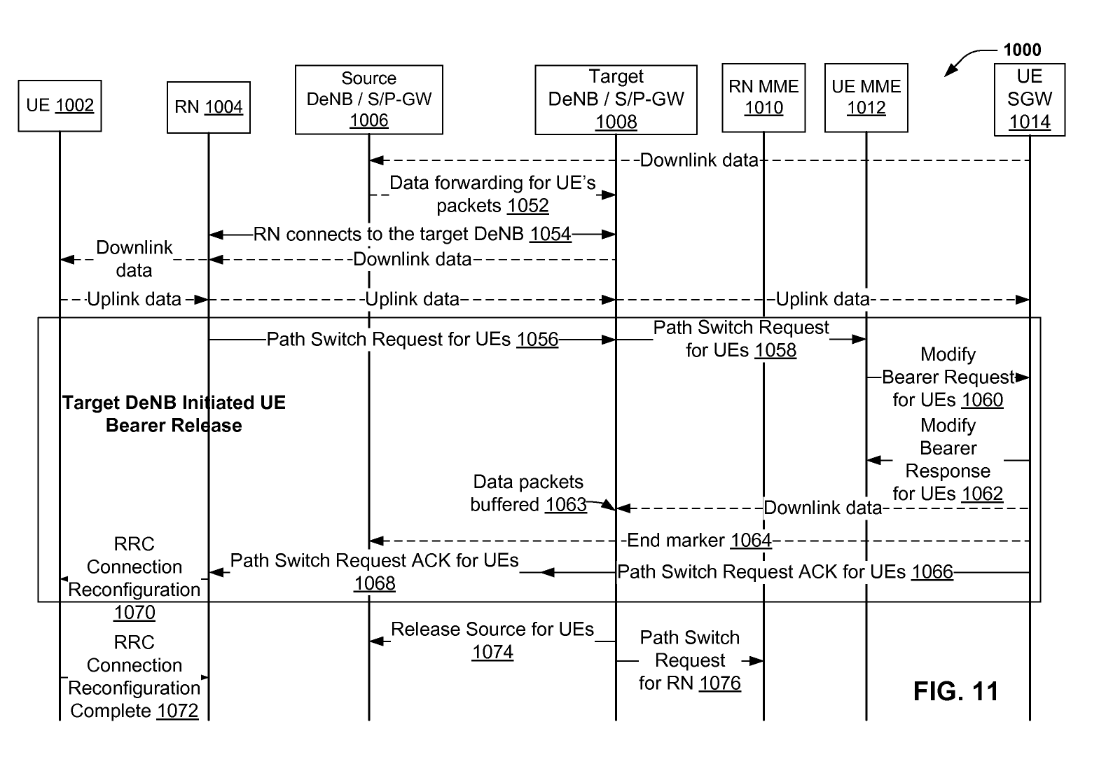

Continuing in FIG. 11, the source DeNB 1006 can forward UE 1002 downlink data packets to the target DeNB 1008 at 1052. RN 1004 subsequently connects to the target DeNB 1008 at 1054. The RN 1004 sends a Path Switch Request message 1056 to UE MME 1012 for UEs, including UE 1002. When the message 1056 reaches the target DeNB 1008, the target DeNB 1008 can obtain the enclosed downlink GTP TEIDs for UE bearers, and can forward the Path Switch Request message 1058 to UE MME 1012. UE MME 1012 sends a Modify Bearer Request 1060 with target DeNB 1008 address and downlink GTP TEIDs for UE bearers to UE S-GW 1014.

UE S-GW 1014 can start sending downlink packets to the target DeNB 1008 using the newly received address and TEIDs. A Modify Bearer Response message 1062 is sent back to UE MME 1012. Moreover, target donor eNB 1008 can begin buffering packets at 1063 so it can first forward data buffered at source DeNB 1006 related to relay 1004 before data received from UE S-GW 1014. UE S-GW 1014 sends an end marker 1064 to the source DeNB 1006 to indicate the end of data to be received for RN

1004. UE MME 1012 sends a Path Switch Response message (Path Switch Request ACK 1066) to target DeNB 1008, which forwards the message 1068 to the RN 1004. The Path Switch Response message 1068, in an example, can include a list of rejected UE bearers. The RN 1004 then sends a RRC Connection Reconfiguration message 1070 to its UE 1002 to delete those UE bearers that are rejected based on the Path Switch Response message 1068, and the UE 1002 can communicate a RRCConnectionReconfigurationComplete message 1072 to RN 1004. The target DeNB 1008 sends a Release Source message 1074 to the source DeNB 1006 to indicate the handover success for at least some UEs of the RN 1004, including UE 1002. The target DeNB 1008 also sends a Path Switch Request message 1076 to RN MME 1010 to switch the path for RN 1004.

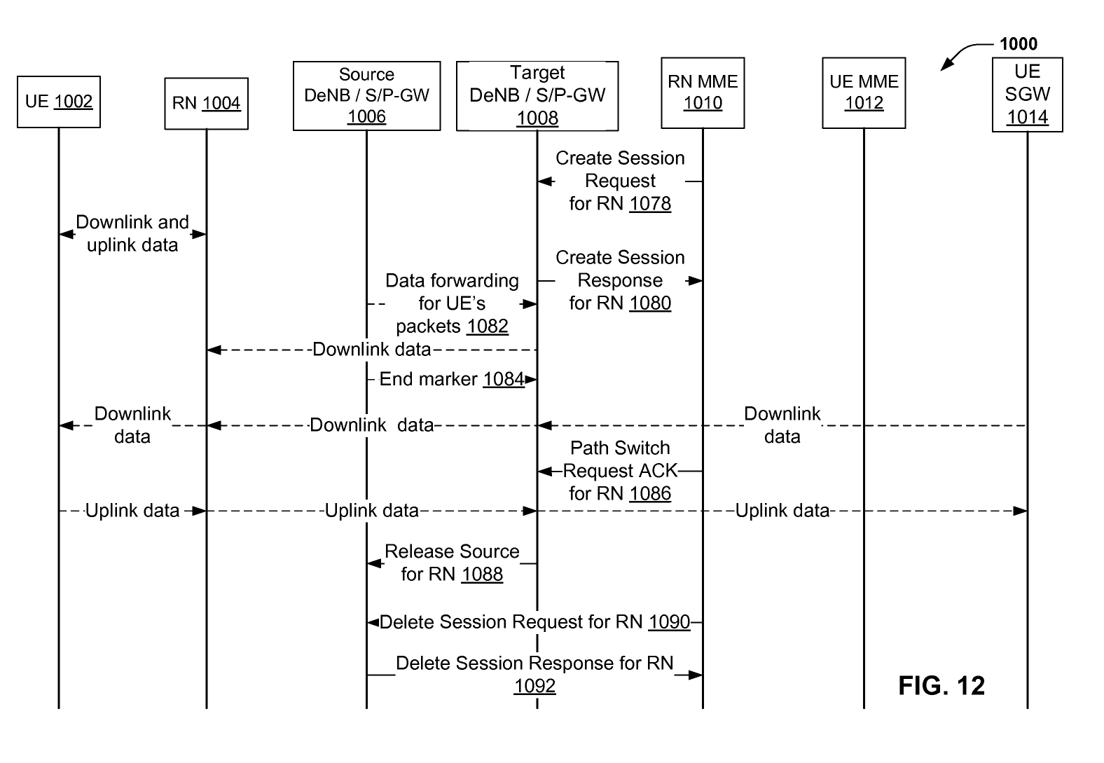

In FIG. 12, RN MME 1010 sends a Create Session Request 1078 to the RN S-GW, at target DeNB 1008, with TFTs for filtering UE packets, such as UE 1002, for successfully established UE bearers. RN target S-GW function, at target DeNB 1008, initiates a session creation procedure with the RN target P-GW function, also at target DeNB 1008. RN S-GW at target DeNB 1008 starts to filter downlink UE packets into RN 1004 bearers. A Create Session Response message 1080 is sent back to RN MME 1010. The target DeNB 1008 can queue the packets that come from UE S-GW 1014 before it sends out all forwarded RNs packets, as described.

Source DeNB 1006 forwards UE packets 1082, and sends an End Marker 1084 to the target DeNB 1008 to indicate its last forwarded RN packets. The target DeNB 1008 can now send out UE packets that come from UE S-GW 1014, as described. RN MME 1010 sends a Path Switch Response message (Path Switch Request ACK 1086) to the target DeNB 1008. The target DeNB 1008 can send uplink data, as shown. By sending Release Resource 1088, the target DeNB 1008 informs success of the handover to source DeNB 1006 and triggers the release of resources. When a timer has expired after sending the Create Session Request 1078 or receiving the Create Session Response 1080 message, RN MME 1010 releases the bearer(s) in the RN source S-GW, in source DeNB 1006, by sending a Delete Session Request message 1090, which is acknowledged by the RN source S-GW, at source DeNB 1006, in a Delete Session Response 1092.

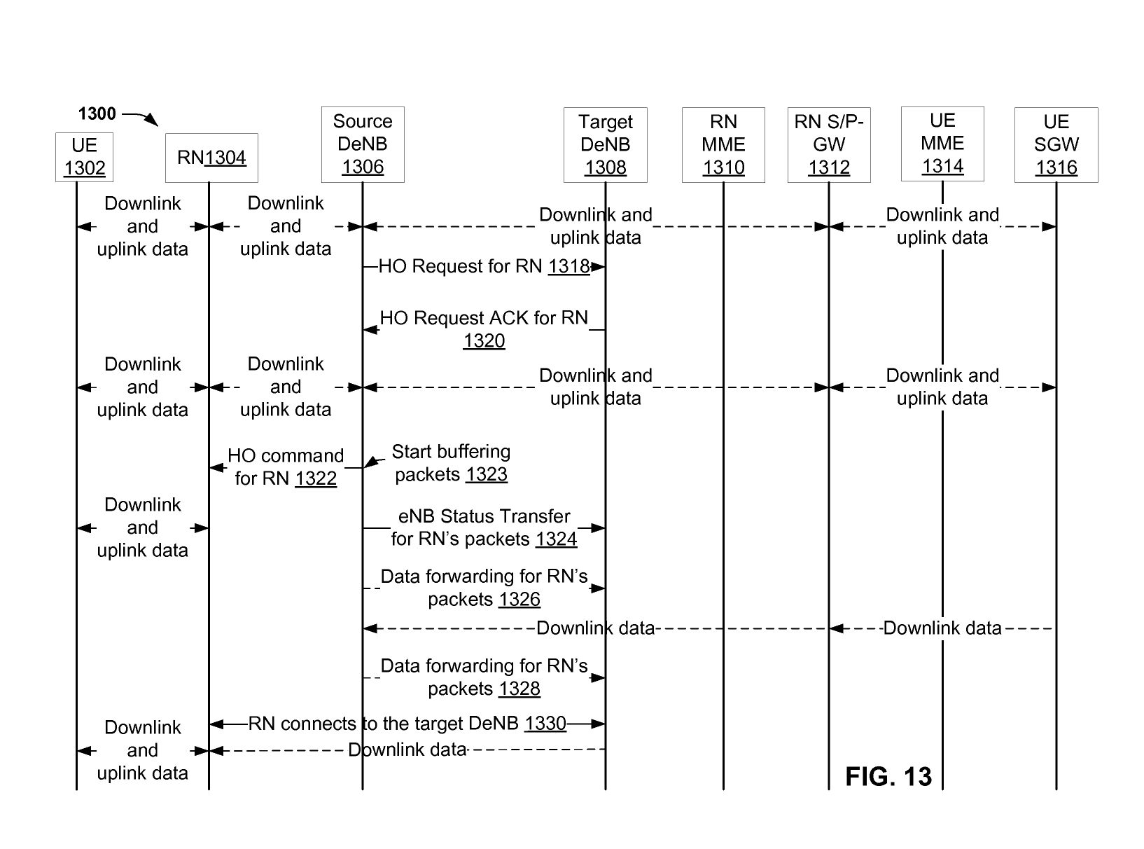

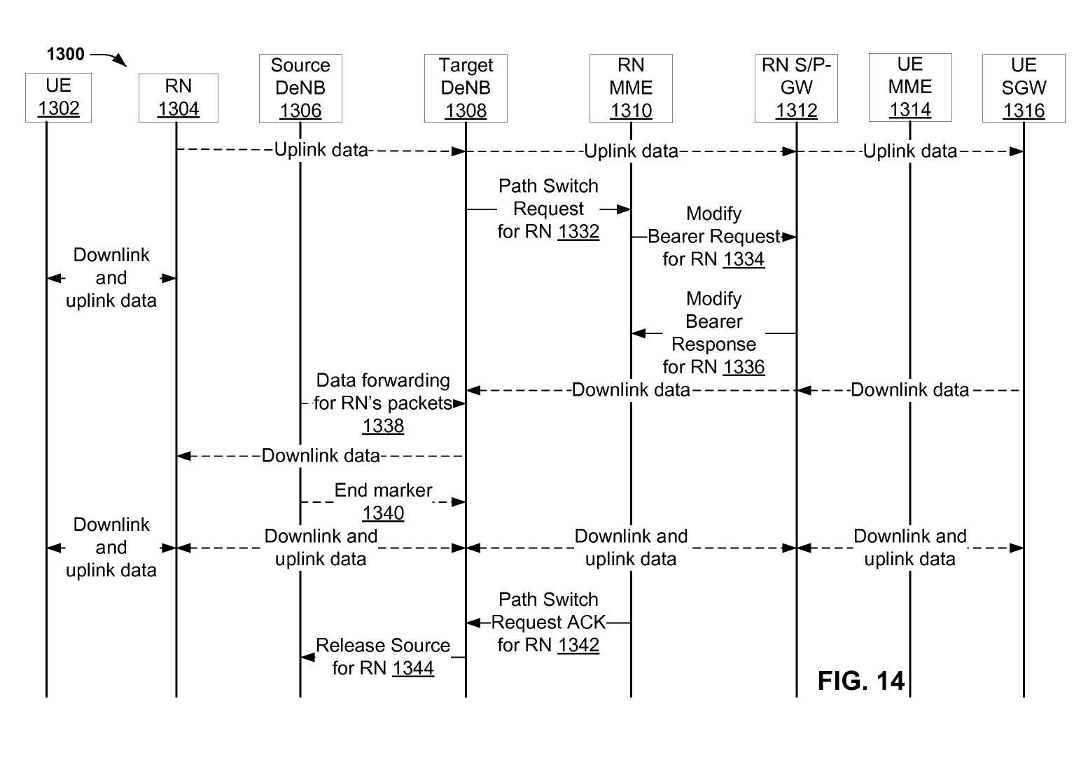

Turning to FIGS. 13-14, an example system 1300 is shown for performing relay handover where a centralized S/P-GW for the relay is employed. In this example, UE bearers need not be handed over since the UE bearers follow the same path through the relay bearers, which are handed over. In addition, in this example, source DeNB 1306 likely does not have UE context information, and thus cannot cause UE handover. For example, system 1300 includes a UE 1302 that communicates with a relay (RN) 1304 for access to a wireless network. RN 1304 communicates with a source DeNB/SIP-GW 1306 (referred to herein as source DeNB 1306) and can be handed over to a target DeNB/S/P-GW 1308 (referred to herein as target DeNB 1308). Moreover, the DeNBs 1306 and 1308 can communicate with a RN MME 1310, a RN S/P-GW 1312, a UE MME 1314, and a UE S-GW 1316, as described previously.

In this example, source DeNB 1306 sends an X2 Handover Request message 1318 to the target DeNB 1308 for RN 1304. This message 1318 can create the RN context in the target DeNB 1308, including information about the bearers, and the security context. The target DeNB 1308 sends an X2 Handover Request ACK message 1320 to the source DeNB 1306 for RN 1304. An EPS Bearer Setup Result, which can be included in the X2 Handover Request ACK message 1320, a list of addresses and TEIDs allocated at the target DeNB 1308 for downlink traffic on S1-U reference and addresses and TEIDs for receiving forwarded data if necessary. The source DeNB 1306 sends the HO command 1322 to RN 1304 to handover RN 1304 to target donor eNB 1308. In addition, the source DeNB 1306 can start buffering packets at 1323 received during the handover procedure for subsequent forwarding to target donor eNB 1308.

Source DeNB 1306 sends an eNB Status Transfer 1324 for all RN packets. For example, this message can transfer outstanding packets (e.g., received in downlink/uplink data shown in FIG. 13) from source donor eNB 1306 to target donor eNB 1308. Source DeNB 1306 can also forward all RN downlink data packets 1326 and/or 1328 (depending on when the downlink data is received) to the target DeNB 1308. RN 1304 connects to the target DeNB 1308 at 1330.

Continuing in FIG. 14, the target DeNB 1308 sends a Path Switch Request message 1332 to RN MME 1310 for RN 1304 to switch the relay bearer paths to route through target donor eNB 1308. RN MME 1310 sends a Modify Bearer Request 1334 to the RN S-GW with Un bearer TFTs that should be used for filtering UE packets into Un bearers of the target DeNB 1308. RN S-GW 1312 starts to filter downlink UE packets into RN bearers. A Modify Bearer Response message 1336 is sent back to RN MME 1310 to confirm the modification. The target DeNB 1308 can also queue the packets that come from UE S-GW 1316 before it sends out all forwarded RNs packets, as described previously.

The source DeNB 1306 can continue forwarding RN 1304 packets 1338 to target DeNB 1308, and can send an End Marker 1340 to the target DeNB to indicate its last forwarded RN packets. The target DeNB 1308, as described, can now send out UE 1302 packets that come from UE S-GW 1316. RN MME 1310 sends a Path Switch Response message (Path Switch Request ACK 1342) to the target DeNB 1308. The target DeNB 1308 can then send uplink data, as shown. By sending Release Resource, 1344, the target DeNB 1308 informs success of the handover to source DeNB 1306 and triggers the release of resources at the source DeNB 1306.

Handover exceptions in this system 1300 can be similar to those previously described except that UE bearer rejection need not be handled as part of handover. For example, if handover of RN 1304 fails, no further handover routines need to be carried out. The RN 1304 may connect to another DeNB by using the attach procedure. If the RN 1304 decides to reconnect to the original DeNB 1306, it can use the RRC reestablishment procedure before the DeNB 1306 removes the RN 1304 and UE (e.g., UE 1302) context. For rejected RN bearers, RN 1304 can be informed about the rejected RN bearers from the HO command 1322. Since it is not necessary that all bearers of a UE 1302 belong to a single RN bearer and it is not necessary that all RN bearers associated with a UE 1302 are rejected, the RN 1304 may not release a UE 1302 entirely. Rather, for example, the RN 1304 may release the UE radio bearers carried by the rejected RN radio bearers by sending an RRCConnectionReconfiguration message to the UE 1302 for the specific UE radio bearers. If the RN 1304 decides to release some UE bearers, the RN 1304 can send the indication of bearer release of those UE bearers to UE MME 1314 as well after it connects to the target DeNB 1308, as shown in previous examples.

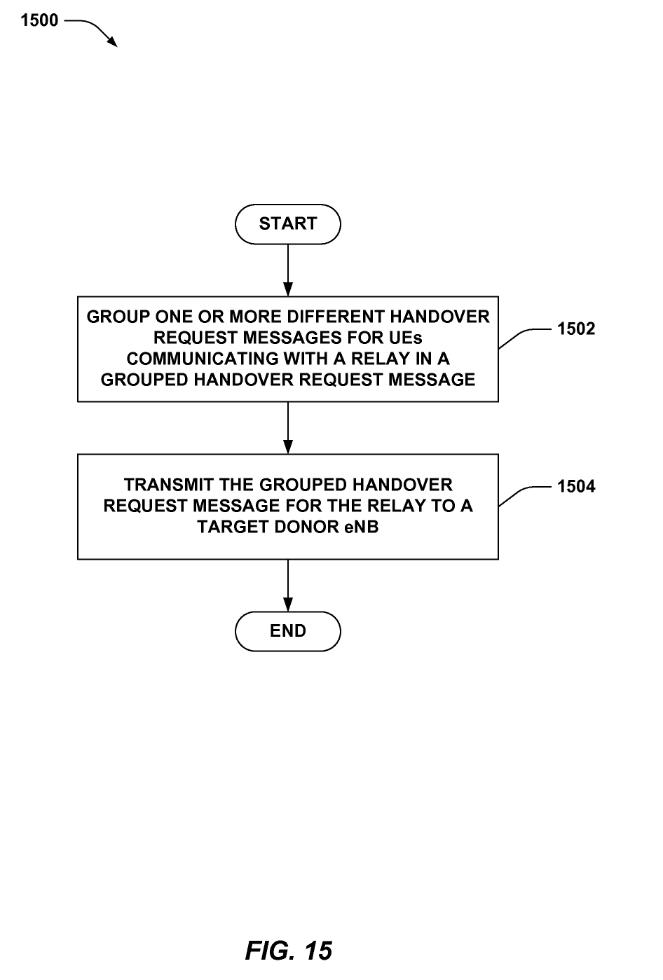

Referring to FIGS. 15-19, example methodologies relating to handing over relays are illustrated. While, for purposes of simplicity of explanation, the methodologies are shown and described as a series of acts, it is to be understood and appreciated that the methodologies are not limited by the order of acts, as some acts may, in accordance with one or more embodiments, occur concurrently with other acts and/or in different orders from that shown and described herein. For example, it is to be appreciated that a methodology could alternatively be represented as a series of interrelated states or events, such as in a state diagram. Moreover, not all illustrated acts may be required to implement a methodology in accordance with one or more embodiments.

Turning to FIG. 15, an example methodology 1500 for handing over a relay and related UEs is illustrated.

At 1502, one or more different handover request messages for UEs communicating with a relay can be grouped in a grouped handover request message. This can conserve signaling required for handing over the UEs of the relay. In one example, a handover request message can also be generated for a relay, and the grouped handover request message can be included as part of the handover request message for the relay. For example, this can be a message to handover the relay based on receiving a measurement report therefrom and determining that a different donor eNB can more effectively serve the relay. Moreover, the handover request message can indicate bearer information for the relay, context information (e.g., security context for the relay), and/or the like. Similarly, the grouped handover request message can include bearer information for the UEs, context information, TEIDs, etc. Moreover, for example, where donor eNBs include S/P-GW functions for the relays, handover of UEs related to the relay can be required, as described, since the S/P-GW function changes as a result of handover. The handover request messages can be grouped such that the relay handover request message includes the different handover request messages, information regarding the handover request messages and/or the like. In addition, the handover request messages can include TEIDs or other UE or related bearer identifiers.

At 1504, the handover request message can be transmitted for the relay to a target donor eNB. For example, the message can be transmitted over a backhaul connection to the target donor eNB. In this regard, the target donor eNB can attempt to establish bearers for the relay and related UEs based on the handover request message, and can communicate grouped handover feedback in response, as described.

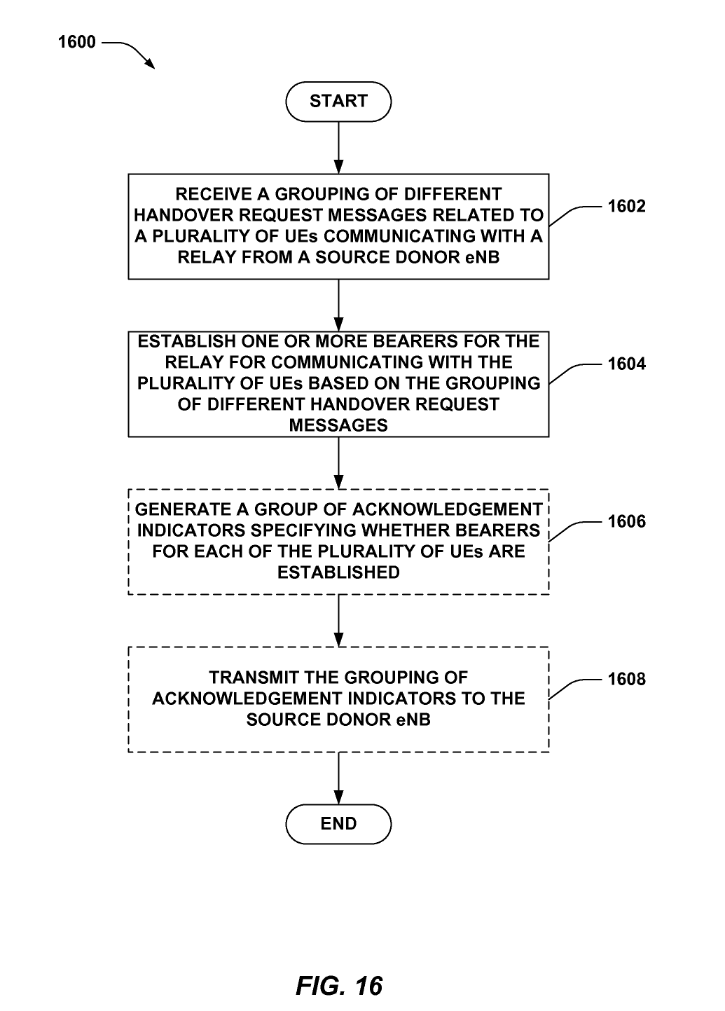

Referring to FIG. 16, an example methodology 1600 is shown for establishing bearers based on grouped handover request messages.

At 1602, a grouping of different handover request messages related to a plurality of UEs communicating with a relay can be received from a source donor eNB. As described, the grouping of handover request messages can be received in a handover request message for a relay, and can be received over a backhaul connection to the source donor eNB. In one example, the handover request messages can also include TEIDs or other identifiers of the UEs or related bearers.

At 1604, one or more bearers can be established for the relay communicating with the plurality of UEs based on the grouping of different handover request messages. For example, this can include establishing network bearers with a S/P-GW related to the relay for corresponding radio bearers with the relay. In another example, this can include establishing network bearers with a S/P-GW related to the UEs for corresponding UE bearers established between the relay and UEs. It is to be appreciated, in some examples, that establishment of some bearers may fail (e.g., due to QoS restrictions, incompatibility or unsupported bearer types, etc.). Moreover, the TEIDs can be used in establishing the bearers to subsequently associate data from the core network for the related bearers, as described.

At 1606, a group of acknowledgement indicators can be generated specifying whether bearers for each of the plurality of UEs are established. For bearers not successfully established, a NAK can be indicated in the group of acknowledgement indicators. Moreover, the group of acknowledgement indicators, or information related thereto, can be generated in a handover request acknowledgement message, as described.

At 1608, the grouping of acknowledgement indicators can be transmitted to the source donor eNB. This can occur over the backhaul connection, for example. The source donor eNB can take various actions, as described, depending on the acknowledgement indicators.

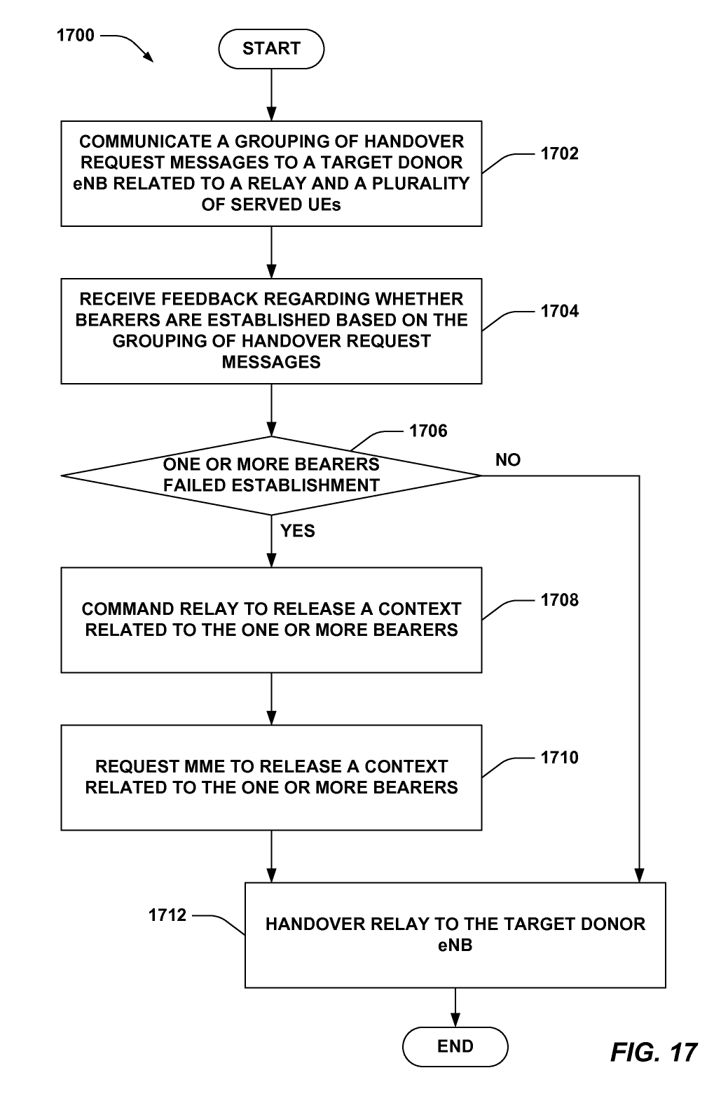

Turning to FIG. 17, an example methodology 1700 is illustrated for requesting handover of a relay and handling associated bearer rejections.

At 1702, a grouping of handover request messages related to a relay and a plurality of served UEs can be communicated to a target donor eNB. As described, this can include transmitting the grouped handover request messages over a backhaul connection, where the messages can be a handover request message for the relay that includes the grouped handover request messages for the UEs or information related thereto.

At 1704, feedback regarding whether bearers are established based on the grouping of handover request messages can be received. As described, the target donor eNB can attempt to establish bearers based on the grouping of handover request messages and can indicate associated feedback. The feedback can be received over the backhaul connection.

At 1706, it can be determined whether one or more bearers failed establishment, which can be based on the feedback. For example, bearers for which NAK is indicated can be determined as failing establishment.

For such bearers, at 1708, the relay can be commanded to release a context related to the one or more bearers. For example, this can include transmitting a UE context release command to the relay over a backhaul connection, as described. The relay can accordingly release the corresponding bearers (e.g., release radio resources allocated to the corresponding bearers).

At 1710, an MME can be requested to release a context related to the one or more bearers. For example, the context can correspond to a network bearer (e.g., EPS bearer) established for the bearer in the core network. The request can be communicated to the MME over the core network.

At 1712, regardless of whether one or more bearers failed establishment at 1706, the relay can be handed over to the target donor eNB. This can include transmitting a handover command to the relay to instruct the relay to communicate with the target donor eNB (e.g., over existing bearers, to establish new bearers therewith, etc.), as described.

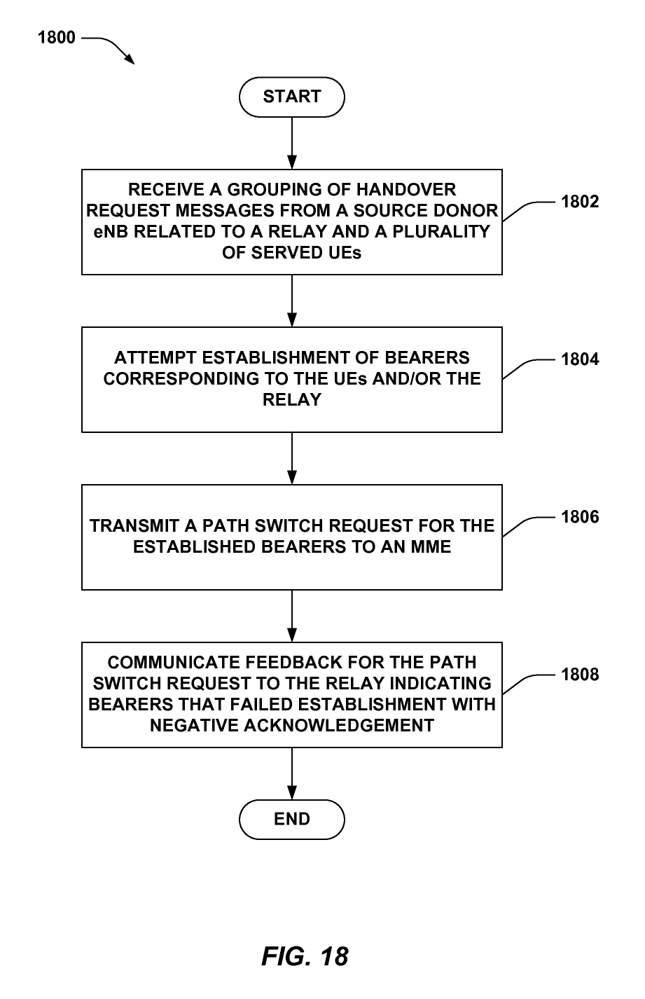

Referring to FIG. 18, an example methodology 1800 that facilitates performing path switching for successfully established bearers in relay handover is illustrated.

At 1802, a grouping of handover request messages related to a relay and a plurality of served UEs can be received from a source donor eNB. For instance, the handover request messages can be received over a backhaul connection, as described.

At 1804, establishment of bearers corresponding to the UEs and/or the relay can be attempted. For example, this can include establishing network bearers in a S/P-GW corresponding to the relay for communicating data over the bearers in a core wireless network. The network bearers can correspond to UE bearers at a relay, relay bearer currently established with the source donor eNB, and/or the like.

At 1806, a path switch request can be transmitted to an MME for the established bearers. The MME can relate to the relay, and the path switch request can be communicated within the core wireless network to the MME such that the MME switches (or causes one or more GWs to switch) the path of data for the bearers to the target donor eNB. Where establishment of bearers failed at 1804, no path switch request needs to be transmitted.

At 1808, feedback for the path switch request can be communicated to the relay indicating bearers that failed establishment with negative acknowledgement. Thus, the relay can analyze the feedback and release any bearers for which establishment failed, which can include releasing the bearer at the UE and/or with the MME on the network side.

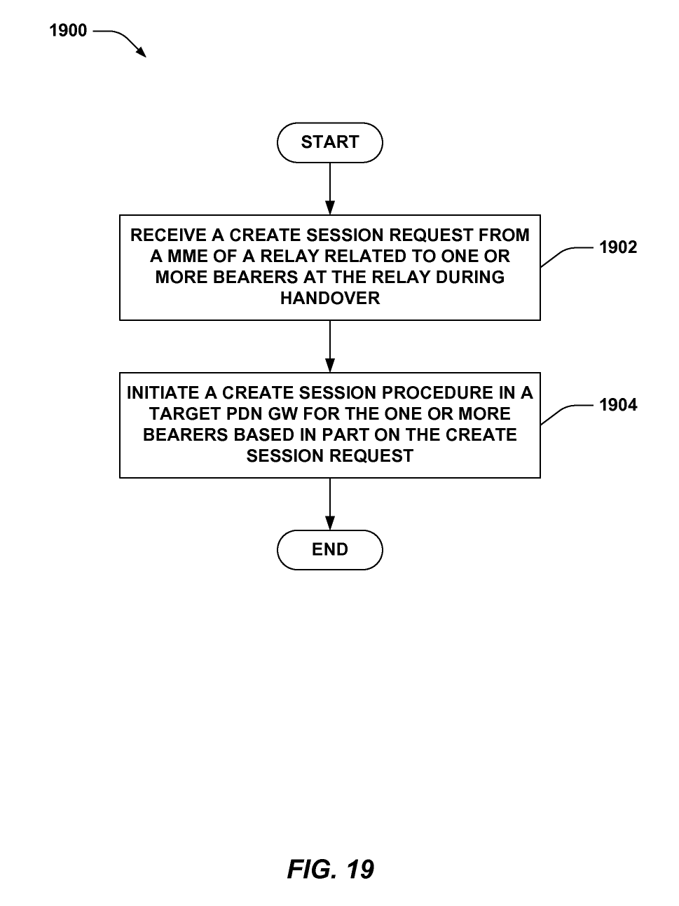

Referring to FIG. 19, an example methodology 1900 that facilitates initiating a create session procedure in a target P-GW for a relay is illustrated.

At 1902, a create session request is received from a MME of a relay related to one or more bearers at the relay during handover. For example, the create session request can be received over an interface in a core wireless network from the MME based on a path switch request transmitted to the MME to modify a path of relay traffic from a source donor eNB in the handover.

At 1904, a create session procedure can be initiated in a target P-GW for the one or more bearers based in part on the create session request. In one example, a target S-GW can receive the create session request, and can initiate the create session procedure in the target P-GW, which can be present within the target DeNB, to facilitate enabling communication over the one or more bearers.

It will be appreciated that, in accordance with one or more aspects described herein, inferences can be made regarding determining information of a grouping of handover request messages, interpreting feedback from the grouped handover request messages, and/or the like, as described. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

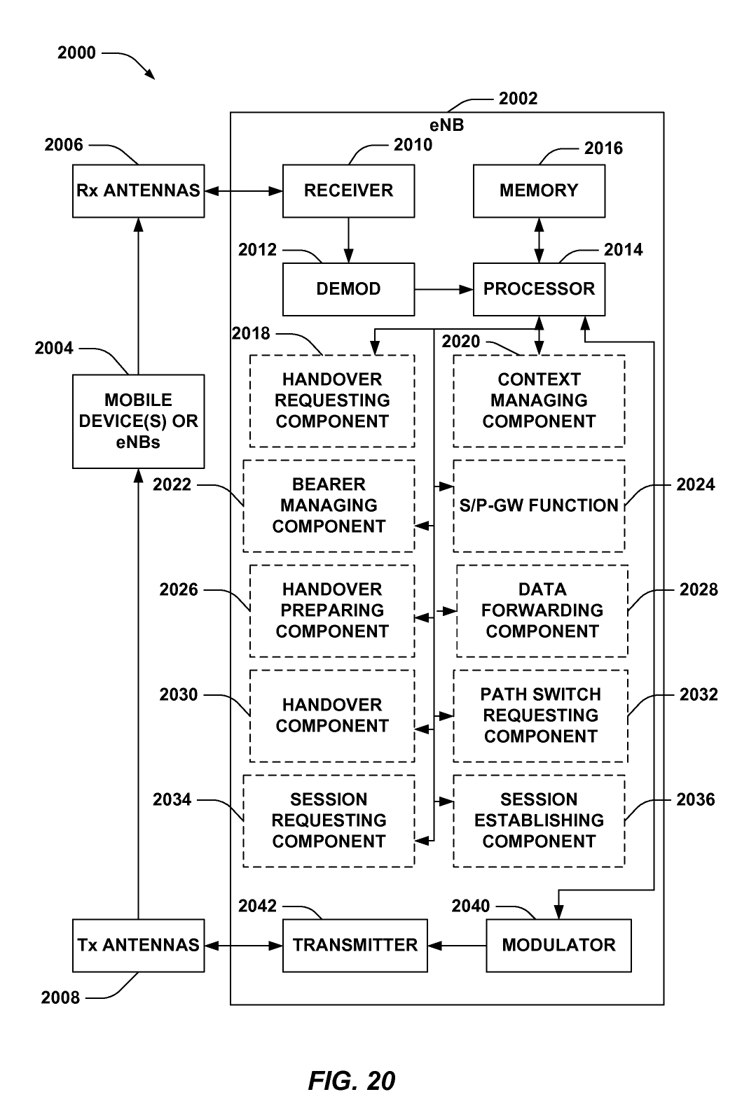

FIG. 20 is an illustration of a system 2000 that facilitates handing over a relay and related UEs. System 2000 includes a eNB 2002 having a receiver 2010 that receives signal(s) from one or more mobile devices or eNBs 2004 through a plurality of receive antennas 2006 (e.g., which can be of multiple network technologies), and a transmitter 2042 that transmits to the one or more mobile devices or eNBs 2004 through a plurality of transmit antennas 2008 (e.g., which can be of multiple network technologies). eNB 2002 can be a relay eNB or donor eNB, as described herein. For example, eNB 2002 can transmit signals received from eNBs 2004 to other eNBs 2004, and/or vice versa. Receiver 2010 can receive information from one or more receive antennas 2006 and is operatively associated with a demodulator 2012 that demodulates received information. In addition, in an example, receiver 2010 can receive from a wired backhaul link. Though depicted as separate antennas, it is to be appreciated that at least one of receive antennas 2006 and a corresponding one of transmit antennas 2008 can be combined as the same antenna. Demodulated symbols are analyzed by a processor 2014, which is coupled to a memory 2016 that stores information related to performing one or more aspects described herein.

Processor 2014, for example, can be a processor dedicated to analyzing information received by receiver 2010 and/or generating information for transmission by a transmitter 2042, a processor that controls one or more components of eNB 2002, and/or a processor that analyzes information received by receiver 2010, generates information for transmission by transmitter 2042, and controls one or more components of eNB 2002. In addition, processor 2014 can perform one or more functions described herein and/or can communicate with components for such a purpose.

Memory 2016, as described, is operatively coupled to processor 2014 and can store data to be transmitted, received data, information related to available channels, data associated with analyzed signal and/or interference strength, information related to an assigned channel, power, rate, or the like, and any other suitable information for estimating a channel and communicating via the channel. Memory 2016 can additionally store protocols and/or algorithms associated with mitigating self-interference of eNB 2002.

It will be appreciated that the data store (e.g., memory 2016) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 2016 of the subject systems and methods is intended to comprise, without being limited to, these and any other suitable types of memory.

Processor 2014 is further optionally coupled to a handover requesting component 2018, which can be similar to handover requesting component 208 and can include a group handover requesting component 214, a context managing component 2020, which can be similar to context managing component 210, a bearer managing component 2022, which can be similar to bearer managing component 212 or 234, and/or a S/P-GW function 2024, which can be similar to S/P-GW functions 216 and 230, target S-GW 308, target P-GW 310, and/or the like. Processor 2014 is also optionally coupled to a handover preparing component 2026, which can be similar to handover preparing component 220 and/or can include components thereof, a data forwarding component 2028, which can be similar to data forwarding component 222, a handover component 2030, which can be similar to handover component 232, and/or a path switch requesting component 2032, which can be similar to path switch requesting component 236. Also, processor 2014 can be optionally coupled to a session requesting component 2034, which can be similar to session requesting component 312, and/or a session establishing component 2036, which can be similar to session establishing component 314.

Moreover, for example, processor 2014 can modulate signals to be transmitted using modulator 2040, and transmit modulated signals using transmitter 2042. Transmitter 2042 can transmit signals to mobile devices or eNBs 2004 over Tx antennas 2008. Furthermore, although depicted as being separate from the processor 2014, it is to be appreciated that the handover requesting component 2018, context managing component 2020, bearer managing component 2022, S/P-GW function 2024, handover preparing component 2026, data forwarding component 2028, handover component 2030, path switch requesting component 2032, session requesting component 2034, session establishing component 2036, demodulator 2012, and/or modulator 2040 can be part of the processor 2014 or multiple processors (not shown), and/or stored as instructions in memory 2016 for execution by processor 2014.

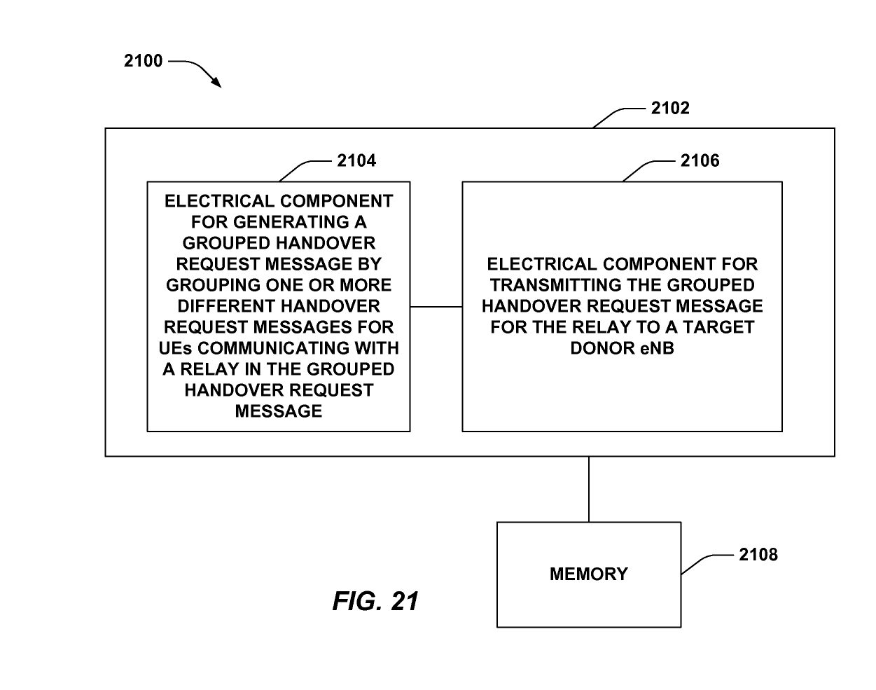

With reference to FIG. 21, illustrated is a system 2100 that communicates grouped handover request messages. For example, system 2100 can reside at least partially within a source donor eNB. It is to be appreciated that system 2100 is represented as including functional blocks, which can be functional blocks that represent functions implemented by a processor, software/firmware, or combinations thereof. System 2100 includes a logical grouping 2102 of components (e.g., electrical components) that can act in conjunction. For instance, logical grouping 2102 can include an electrical component for generating a grouped handover request message by grouping one or more different handover request messages for UEs communicating with a relay in the grouped handover request message (2104). Further, logical grouping 2102 can include an electrical component for transmitting the grouped handover request message for the relay to a target donor eNB (2106).

As described, for example, transmitting the messages as grouped can minimize signaling required to handover a relay. For example, electrical component 2104 can include a group handover requesting component 214. In addition, for example, electrical component 2106, in an aspect, can include a handover requesting component 208, for example.

Additionally, system 2100 can include a memory 2108 that retains instructions for executing functions associated with the electrical components 2104 and 2106. While shown as being external to memory 2108, it is to be understood that one or more of the electrical components 2104 and 2106 can exist within memory 2108. In one example, electrical components 2104 and 2106 can include at least one processor, or each electrical component 2104 and 2106 can be a corresponding module of at least one processor. Moreover, in an additional or alternative example, components 2104 and 2106 can be a computer program product comprising a computer readable medium, where each component 2104 and 2106 can be corresponding code.

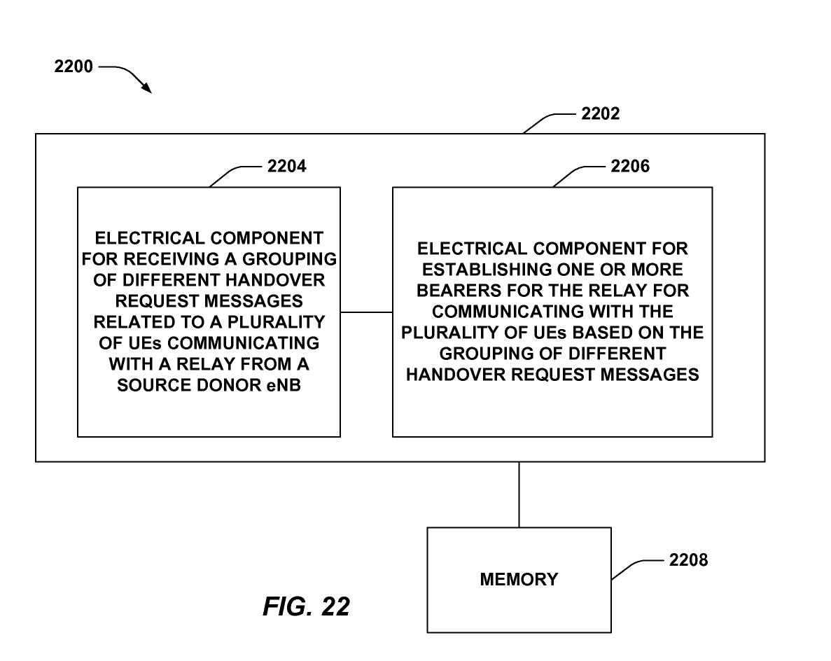

With reference to FIG. 22, illustrated is a system 2200 that establishes bearers for a relay and associated UEs in handover. For example, system 2200 can reside at least partially within a target donor eNB. It is to be appreciated that system 2200 is represented as including functional blocks, which can be functional blocks that represent functions implemented by a processor, software/firmware, or combinations thereof. System 2200 includes a logical grouping 2202 of components (e.g., electrical components) that can act in conjunction. For instance, logical grouping 2202 can include an electrical component for receiving a grouping of different handover request messages related to a plurality of UEs communicating with a relay from a source donor eNB (2204). Further, logical grouping 2202 can include an electrical component for establishing one or more bearers for communicating with the plurality of UEs based on the grouping of different handover request messages (2206).

As described, for example, grouped feedback indicating whether each of the one or more bearers are successfully established can additionally be generated for transmitting by electrical component 2204. For example, electrical component 2204 can include a group handover receiving component 224. In addition, for example, electrical component 2206, in an aspect, can include a bearer establishing component 228, for example.

Additionally, system 2200 can include a memory 2208 that retains instructions for executing functions associated with the electrical components 2204 and 2206. While shown as being external to memory 2208, it is to be understood that one or more of the electrical components 2204 and 2206 can exist within memory 2208. In one example, electrical components 2204 and 2206 can include at least one processor, or each electrical component 2204 and 2206 can be a corresponding module of at least one processor. Moreover, in an additional or alternative example, components 2204 and 2206 can be a computer program product comprising a computer readable medium, where each component 2204 and 2206 can be corresponding code.

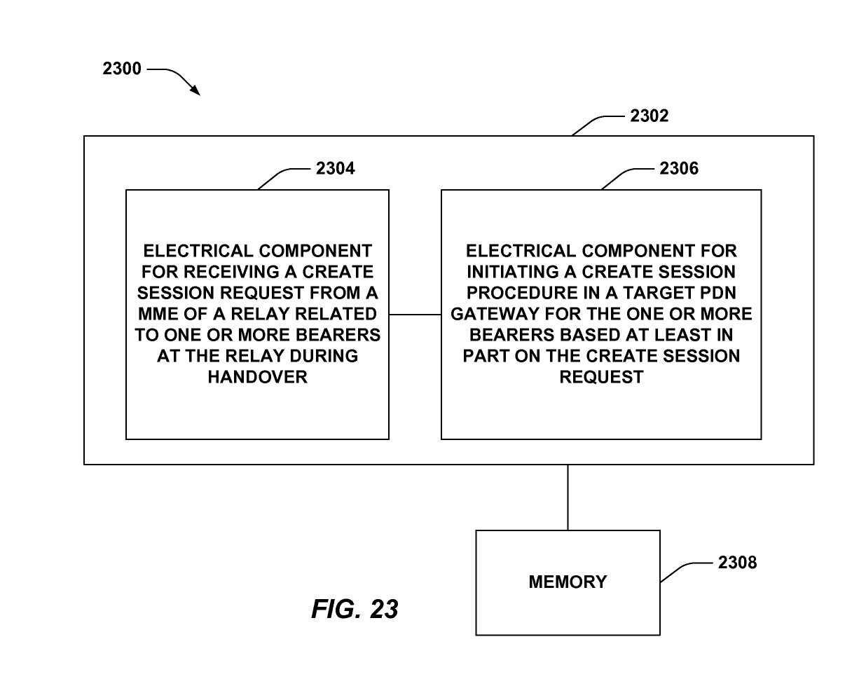

With reference to FIG. 23, illustrated is a system 2300 that initiates a create session procedure in a target P-GW. For example, system 2300 can reside at least partially within a S-GW function of a target DeNB. It is to be appreciated that system 2300 is represented as including functional blocks, which can be functional blocks that represent functions implemented by a processor, software/firmware, or combinations thereof. System 2300 includes a logical grouping 2302 of components (e.g., electrical components) that can act in conjunction. For instance, logical grouping 2302 can include an electrical component for receiving a create session request from a MME of a relay related to one or more bearers at the relay during handover (2304). Further, logical grouping 2302 can include an electrical component for initiating a create session procedure in a target P-GW for the one or more bearers at least in part on the create session request (2306).

For example, electrical component 2304 can include a session requesting component 312. In addition, for example, electrical component 2306, in an aspect, can include a session establishing component 314, for example.

Additionally, system 2300 can include a memory 2308 that retains instructions for executing functions associated with the electrical components 2304 and 2306. While shown as being external to memory 2308, it is to be understood that one or more of the electrical components 2304 and 2306 can exist within memory 2308. In one example, electrical components 2304 and 2306 can include at least one processor, or each electrical component 2304 and 2306 can be a corresponding module of at least one processor. Moreover, in an additional or alternative example, components 2304 and 2306 can be a computer program product comprising a computer readable medium, where each component 2304 and 2306 can be corresponding code.

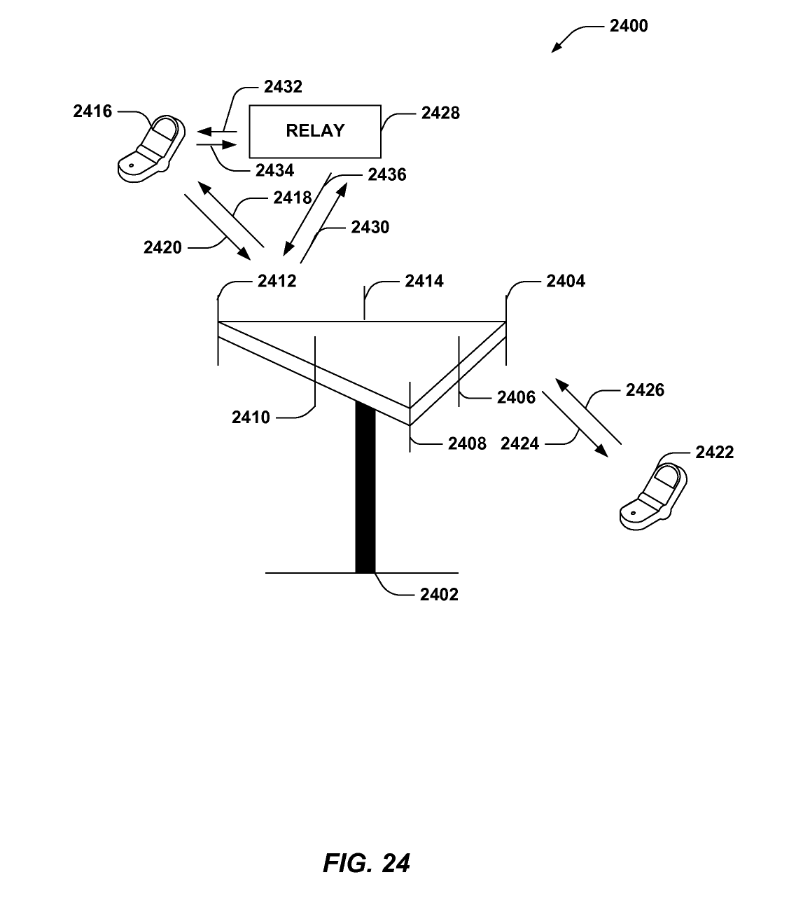

Referring now to FIG. 24, a wireless communication system 2400 is illustrated in accordance with various embodiments presented herein. System 2400 includes a base station 2402 that can include multiple antenna groups. For example, one antenna group can include antennas 2404 and 2406, another group can include antennas 2408 and 2410, and an additional group can include antennas 2412 and 2414. Two antennas are illustrated for each antenna group; however, more or fewer antennas can be utilized for each group. Base station 2402 can additionally include a transmitter chain and a receiver chain, each of which can in turn include a plurality of components associated with signal transmission and reception (e.g., processors, modulators, multiplexers, demodulators, demultiplexers, antennas, etc.), as is appreciated.

Base station 2402 can communicate with one or more mobile devices such as mobile device 2416 and mobile device 2422; however, it is to be appreciated that base station 2402 can communicate with substantially any number of mobile devices similar to mobile devices 2416 and 2422. Mobile devices 2416 and 2422 can be, for example, cellular phones, smart phones, laptops, handheld communication devices, handheld computing devices, satellite radios, positioning systems (e.g., GPS), PDAs, tablets, smart books, netbooks, and/or any other suitable device for communicating over wireless communication system 2400. As depicted, mobile device 2416 is in communication with antennas 2412 and 2414, where antennas 2412 and 2414 transmit information to mobile device 2416 over a forward link 2418 and receive information from mobile device 2416 over a reverse link 2420. Moreover, mobile device 2422 is in communication with antennas 2404 and 2406, where antennas 2404 and 2406 transmit information to mobile device 2422 over a forward link 2424 and receive information from mobile device 2422 over a reverse link 2426. In a frequency division duplex (FDD) system, forward link 2418 can utilize a different frequency band than that used by reverse link 2420, and forward link 2424 can employ a different frequency band than that employed by reverse link 2426, for example. Further, in a time division duplex (TDD) system, forward link 2418 and reverse link 2420 can utilize a common frequency band and forward link 2424 and reverse link 2426 can utilize a common frequency band.

Each group of antennas and/or the area in which they are designated to communicate can be referred to as a sector of base station 2402. For example, antenna groups can be designed to communicate to mobile devices in a sector of the areas covered by base station 2402. In communication over forward links 2418 and 2424, the transmitting antennas of base station 2402 can utilize beamforming to improve signal-to-noise ratio of forward links 2418 and 2424 for mobile devices 2416 and 2422. Also, while base station 2402 utilizes beamforming to transmit to mobile devices 2416 and 2422 scattered randomly through an associated coverage area, mobile devices in neighboring cells can be subject to less interference as compared to a base station transmitting through a single antenna to all its mobile devices. Moreover, mobile devices 2416 and 2422 can communicate directly with one another using a peer-to-peer or ad hoc technology. According to an example, system 2400 can be a multiple-input multiple-output (MIMO) communication system.

In addition, system 2400 includes a relay 2428 that can facilitate receiving and transmitting signals from base station 2402 to mobile device 2416, and/or vice versa. For example, relay 2428 can receive signals from base station 2402 over forward link 2430, and can transmit the signals to mobile device 2416 over forward link 2432. Thus, for example, mobile device 2416 can receive signals related to base station 2402 over forward links 2418 and/or 2432. In another example, relay 2428 can receive signals from mobile device 2416 over reverse link 2434, and can similarly transmit the signals to base station 2402 over reverse link 2436. Relay 2428 can serve a number of mobile devices. In addition, relay 2428 can be handed over to or from base station 2402, which can include handing over mobile device 2416 as well. Additional core network communications can occur, as described, in completing handover of relay 2428 and mobile devices communicating therewith.

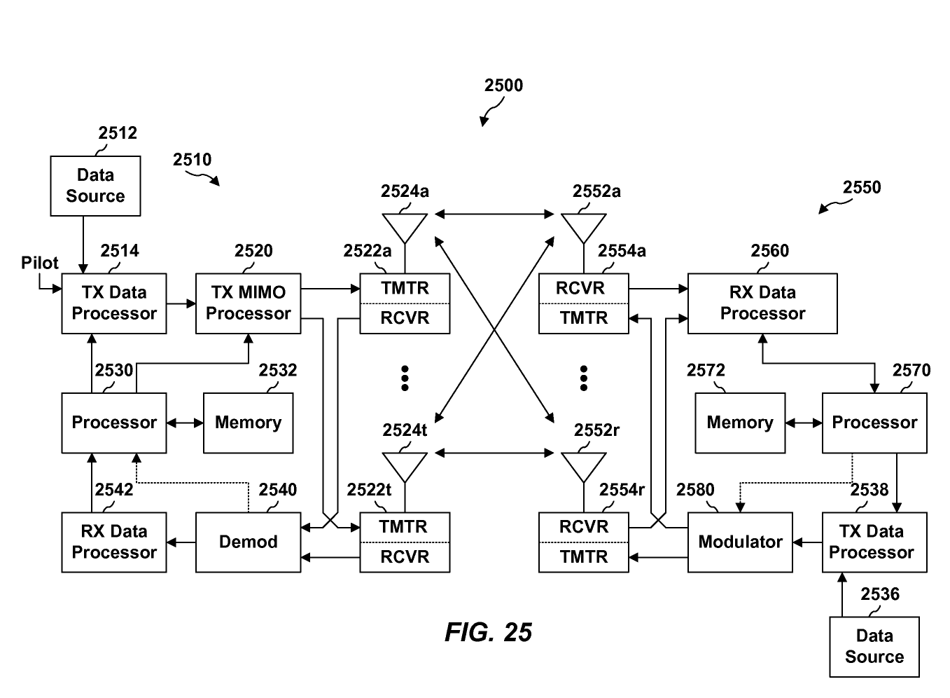

FIG. 25 shows an example wireless communication system 2500. The wireless communication system 2500 depicts one base station 2510 and one mobile device 2550 for sake of brevity. However, it is to be appreciated that system 2500 can include more than one base station and/or more than one mobile device, wherein additional base stations and/or mobile devices can be substantially similar or different from example base station 2510 and mobile device 2550 described below. In addition, it is to be appreciated that base station 2510 and/or mobile device 2550 can employ the systems (FIGS. 1-14 and 20-24) and/or methods (FIGS. 15-19) described herein to facilitate wireless communication there between. For example, components or functions of the systems and/or methods described herein can be part of a memory 2532 and/or 2572 or processors 2530 and/or 2570 described below, and/or can be executed by processors 2530 and/or 2570 to perform the disclosed functions.

At base station 2510, traffic data for a number of data streams is provided from a data source 2512 to a transmit (TX) data processor 2514. According to an example, each data stream can be transmitted over a respective antenna. TX data processor 2514 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 2550 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 2530.

The modulation symbols for the data streams can be provided to a TX MIMO processor 2520, which can further process the modulation symbols (e.g., for OFDM). TX MIMO processor 2520 then provides N_{T} modulation symbol streams to N_{T} transmitters (TMTR) 2522a through 2522t. In various embodiments, TX MIMO processor 2520 applies beamforming weights to the symbols of the data streams and to the antenna from which the symbol is being transmitted.

Each transmitter 2522 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 2522a through 2522t are transmitted from N_{T} antennas 2524a through 2524t, respectively.

At mobile device 2550, the transmitted modulated signals are received by N_{R} antennas 2552a through 2552r and the received signal from each antenna 2552 is provided to a respective receiver (RCVR) 2554a through 2554r. Each receiver 2554 conditions (e.g., filters, amplifies, and downconverts) a respective signal, digitizes the conditioned signal to provide samples, and further processes the samples to provide a corresponding “received” symbol stream.

An RX data processor 2560 can receive and process the N_{R} received symbol streams from N_{R} receivers 2554 based on a particular receiver processing technique to provide N_{T} “detected” symbol streams. RX data processor 2560 can demodulate, deinterleave, and decode each detected symbol stream to recover the traffic data for the data stream. The processing by RX data processor 2560 is complementary to that performed by TX MIMO processor 2520 and TX data processor 2514 at base station 2510.

The reverse link message can comprise various types of information regarding the communication link and/or the received data stream. The reverse link message can be processed by a TX data processor 2538, which also receives traffic data for a number of data streams from a data source 2536, modulated by a modulator 2580, conditioned by transmitters 2554a through 2554r, and transmitted back to base station 2510.

At base station 2510, the modulated signals from mobile device 2550 are received by antennas 2524, conditioned by receivers 2522, demodulated by a demodulator 2540, and processed by a RX data processor 2542 to extract the reverse link message transmitted by mobile device 2550. Further, processor 2530 can process the extracted message to determine which precoding matrix to use for determining the beamforming weights.

Processors 2530 and 2570 can direct (e.g., control, coordinate, manage, etc.) operation at base station 2510 and mobile device 2550, respectively. Respective processors 2530 and 2570 can be associated with memory 2532 and 2572 that store program codes and data. In another example, portions of the base station 2510 and portions of device 2550 can be implemented within a relay to provide functionality as described herein. Thus, for example, processors 2530 and 2570 can also handover a relay and related UEs, as described, which can include various communications over the air to the relay and/or UE, and within the core network over a backhaul link (not shown).

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal.

In one or more aspects, the functions, methods, or algorithms described may be implemented in hardware, software/firmware, or combinations thereof. If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, substantially any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for handing over a relay and associated user equipment (UE), comprising:
grouping one or more different handover request messages for UEs communicating with a relay in a grouped handover request message; and
transmitting the grouped handover request message to a target donor evolved Node B (eNB).

2. The method of claim 1, further comprising receiving a grouping of acknowledgement indicators related to the each of the one or more different handover request messages in the grouped handover request message from the target donor eNB.

3. The method of claim 2, further comprising removing a context of at least one of the UEs based at least in part on at least one of the grouping of acknowledgement indicators specifying a negative acknowledgment for the at least one of the UEs.

4. The method of claim 3, wherein the removing the context comprises requesting a mobility management entity related to the UE to release the context.

5. The method of claim 3, further comprising instructing the relay to deactivate a bearer with at least one of the UEs based at least in part on the negative acknowledgment.

6. The method of claim 1, further comprising specifying one or more tunnel endpoint identifiers related to the UEs in the grouped handover request message.

7. The method of claim 1, further comprising generating a handover request message for the relay, wherein the handover request message comprises the grouped handover request message.

8. The method of claim 7, further comprising receiving a grouping of acknowledgement indicators related to the handover request message and each of the one or more different handover request messages in the grouped handover request message from the target donor eNB.

9. An apparatus for handing over a relay and associated user equipment (UE), comprising:
at least one processor configured to:
group one or more different handover request messages for UEs communicating with a relay in a grouped handover request message; and
transmit the grouped handover request message to a target donor evolved Node B (eNB); and
a memory coupled to the at least one processor.

10. The apparatus of claim 9, wherein the at least one processor is further configured to receive a grouping of acknowledgement indicators from the target donor eNB related to each of the one or more different handover request messages in the grouped handover request message.

11. The apparatus of claim 10, wherein the at least one processor is further configured to remove a context of at least one of the UEs based at least in part on at least one of the grouping of acknowledgement indicators specifying a negative acknowledgment for at least one of the UEs.

12. The apparatus of claim 11, wherein the at least one processor removes the context in part by requesting a mobility management entity related to the UE to release the context.

13. The apparatus of claim 11, wherein the at least one processor is further configured to request the relay to deactivate a bearer with at least one of the UEs based at least in part on the negative acknowledgment.

14. The apparatus of claim 9, wherein the at least one processor is further configured to specify one or more tunnel endpoint identifiers related to the UEs in the grouped handover request message.

15. The apparatus of claim 9, wherein the at least one processor is further configured to generate a handover request message for the relay, wherein the handover request message comprises the grouped handover request message.

16. The apparatus of claim 15, wherein the at least one processor is further configured to receive a grouping of acknowledgement indicators related to the handover request message and each of the one or more different handover request messages in the grouped handover request message from the target donor eNB.

17. An apparatus for handing over a relay and associated user equipment (UE), comprising:
means for generating a grouped handover request message by grouping one or more different handover request messages for UEs communicating with a relay in the grouped handover request message; and
means for transmitting the grouped handover request message for the relay to a target donor evolved Node B (eNB).

18. The apparatus of claim 17, wherein the means for transmitting receives a grouping of acknowledgement indicators related to each of the one or more different handover request messages in the grouped handover request message from the target donor eNB.

19. The apparatus of claim 18, further comprising means for removing a context of at least one of the UEs based at least in part on determining that at least one of the grouping of acknowledgement indicators specifies a negative acknowledgment for the at least one of the UEs.

20. The apparatus of claim 19, wherein the means for removing the context requests a mobility management entity related to the UE to release the context.

21. The apparatus of claim 19, further comprising means for instructing the relay to deactivate a bearer with at least one of the UEs based at least in part on the negative acknowledgment.

22. The apparatus of claim 17, wherein the means for generating specifies one or more tunnel endpoint identifiers related to the UEs in the grouped handover request message.

23. The apparatus of claim 17, wherein the means for generating generates a handover request message for the relay, wherein the handover request message comprises the grouped handover request message.

24. The apparatus of claim 23, wherein the means for transmitting receives a grouping of acknowledgement indicators related to the handover request message and each of the one or more different handover request messages in the grouped handover request message from the target donor eNB.

25. A computer program product for handing over a relay and associated user equipment (UE), comprising:
a computer-readable medium, comprising:
code for causing at least one computer to group one or more different handover request messages for UEs communicating with a relay in a grouped handover request message; and
code for causing the at least one computer to transmit the grouped handover request message for the relay to a target donor evolved Node B (eNB).

26. The computer program product of claim 25, wherein the computer-readable medium further comprises code for causing the at least one computer to receive a grouping of acknowledgement indicators related to each of the one or more different handover request messages in the grouped handover request message from the target donor eNB.

27. The computer program product of claim 26, wherein the computer-readable medium further comprises code for causing the at least one computer to remove a context of at least one of the UEs based at least in part on at least one of the grouping of acknowledgement indicators specifying a negative acknowledgment for the at least one of the UEs.

28. The computer program product of claim 27, wherein the code for causing the at least one computer to remove the context requests a mobility management entity related to the UE to release the context.

29. The computer program product of claim 27, wherein the computer-readable medium further comprises code for causing the at least one computer to request the relay to deactivate a bearer with at least one of the UEs based at least in part on at the negative acknowledgment.

30. The computer program product of claim 25, wherein the computer-readable medium further comprises code for causing the at least one computer to specify one or more tunnel endpoint identifiers related to the UEs in the grouped handover request message.

31. The computer program product of claim 25, wherein the computer-readable medium further comprises code for causing the at least one computer to generate a handover request message for the relay, wherein the handover request message comprises the grouped handover request message.

32. The computer program product of claim 31, wherein the computer-readable medium further comprises code for causing the at least one computer to receive a grouping of acknowledgement indicators related to the handover request message and each of the one or more different handover request messages in the grouped handover request message from the target donor eNB.

33. An apparatus for handing over a relay and associated user equipment (UE), comprising:
a group handover requesting component for generating a grouped handover request message by grouping one or more different handover request messages for UEs communicating with a relay in the grouped handover request message; and
a handover requesting component for transmitting the grouped handover request message for the relay to a target donor evolved Node B (eNB).

34. The apparatus of claim 33, wherein the handover requesting component receives a grouping of acknowledgement indicators related to each of the one or more different handover request messages in the grouped handover request message from the target donor eNB.

35. The apparatus of claim 34, further comprising a context managing component for removing a context of at least one of the UEs based at least in part on determining that at least one of the grouping of acknowledgement indicators specifies a negative acknowledgment for the at least one of the UEs.

36. The apparatus of claim 35, wherein the context managing component requests a mobility management entity related to the UE to release the context.

37. The apparatus of claim 35, further comprising a bearer managing component for instructing the relay to deactivate a bearer with at least one of the UEs based at least in part on the negative acknowledgment.

38. The apparatus of claim 33, wherein the group handover requesting component specifies one or more tunnel endpoint identifiers related to the UEs in the grouped handover request message.

39. The apparatus of claim 33, wherein the group handover requesting component generates a handover request message for the relay, wherein the handover request message comprises the grouped handover request message.

40. The apparatus of claim 39, wherein the handover requesting component receives a grouping of acknowledgement indicators related to the handover request message and each of the one or more different handover request messages in the grouped handover request message from the target donor eNB.

41. A method for handing over a relay and associated user equipment (UE), comprising:
receiving a grouping of different handover request messages related to a plurality of UEs communicating with a relay from a source donor evolved Node B (eNB); and
establishing one or more bearers for the relay for communicating with the plurality of UEs based on the grouping of different handover request messages.

42. The method of claim 41, further comprising:
generating a grouping of acknowledgement indicators specifying whether bearers for each of the plurality of UEs are established based on the establishing; and
transmitting the grouping of acknowledgement indicators to the source donor eNB.

43. The method of claim 41, wherein the grouping of different handover request messages includes one or more tunnel endpoint identifiers (TEID) related to the plurality of UEs.

44. The method of claim 43, further comprising requesting, from a mobility management entity related to the relay, a path switch for the one or more TEIDs to the one or more bearers.

45. The method of claim 44, further comprising receiving a path switch request from the relay, wherein the requesting is based on receiving the path switch request.

46. The method of claim 45, further comprising indicating a negative acknowledgement in a path switch response to the relay for at least one of one or more TEIDs related to a failed bearer establishment.

47. The method of claim 41, further comprising forwarding relay bearer packets received from the source donor eNB to the relay over the one or more bearers before forwarding UE bearer packets received from the source donor eNB to at least one of the plurality of UEs over the one or more bearers.

48. The method of claim 41, further comprising establishing a temporary network address for the relay to facilitate communicating during handover.

49. An apparatus for handing over a relay and associated user equipment (UE), comprising:
at least one processor configured to:
receive a grouping of different handover request messages related to a plurality of UEs communicating with a relay from a source donor evolved Node B (eNB); and
establish one or more bearers for the relay for communicating with the plurality of UEs based on the grouping of different handover request messages; and
a memory coupled to the at least one processor.

50. The apparatus of claim 49, wherein the at least one processor is further configured to:
generate a grouping of acknowledgement indicators specifying whether bearers for each of the plurality of UEs are established; and
transmit the grouping of acknowledgement indicators to the source donor eNB.

51. The apparatus of claim 49, wherein the grouping of different handover request messages includes one or more tunnel endpoint identifiers (TEID) related to the plurality of UEs.

52. The apparatus of claim 51, wherein the at least one processor is further configured to request, from a mobility management entity related to the relay, a path switch for the one or more TEIDs to the one or more bearers.

53. The apparatus of claim 49, wherein the at least one processor is further configured to forward relay bearer packets received from the source donor eNB to the relay over the one or more bearers before forwarding UE bearer packets received from the source donor eNB to at least one of the plurality of UEs over the one or more bearers.

54. The apparatus of claim 49, wherein the at least one processor is further configured to establish a temporary network address for the relay to facilitate communicating during handover.

55. An apparatus for handing over a relay and associated user equipment (UE), comprising:
means for receiving a grouping of different handover request messages related to a plurality of UEs communicating with a relay from a source donor evolved Node B (eNB); and
means for establishing one or more bearers for the relay for communicating with the plurality of UEs based on the grouping of different handover request messages.

56. The apparatus of claim 55, wherein the means for establishing further generates a grouping of acknowledgement indicators specifying whether bearers for each of the plurality of UEs are established.

57. The apparatus of claim 55, wherein the grouping of different handover request messages includes one or more tunnel endpoint identifiers (TEID) related to the plurality of UEs.

58. The apparatus of claim 57, wherein the means for establishing the one or more bearers requests, from a mobility management entity related to the relay, a path switch for the one or more TEIDs to the one or more bearers.

59. The apparatus of claim 55, further comprising means for forwarding relay bearer packets received from the source donor eNB to the relay over the one or more bearers before forwarding UE bearer packets received from the source donor eNB to at least one of the plurality of UEs over the one or more bearers.

60. The apparatus of claim 55, further comprising means for establishing a temporary network address for the relay to facilitate communicating during handover.

61. A computer program product for handing over a relay and associated user equipment (UE), comprising:
a computer-readable medium, comprising:
code for causing at least one computer to receive a grouping of different handover request messages related to a plurality of UEs communicating with a relay from a source donor evolved Node B (eNB); and
code for causing the at least one computer to establish one or more bearers for the relay for communicating with the plurality of UEs based on the grouping of different handover request messages.

62. The computer program product of claim 61, wherein the computer-readable medium further comprises:
code for causing the at least one computer to generate a grouping of acknowledgement indicators specifying whether bearers for each of the plurality of UEs are established; and
code for causing the at least one computer to transmit the grouping of acknowledgement indicators to the source donor eNB.

63. The computer program product of claim 61, wherein the grouping of different handover request messages includes one or more tunnel endpoint identifiers (TEID) related to the plurality of UEs.

64. The computer program product of claim 63, wherein the computer-readable medium further comprises code for causing the at least one computer to request, from a mobility management entity related to the relay, a path switch for the one or more TEIDs to the one or more bearers.

65. The computer program product of claim 61, wherein the computer-readable medium further comprises code for causing the at least one computer to forward relay bearer packets received from the source donor eNB to the relay over the one or more bearers before forwarding UE bearer packets received from the source donor eNB to at least one of the plurality of UEs over the one or more bearers.

66. The computer program product of claim 61, wherein the computer-readable medium further comprises code for causing the at least one computer to establish a temporary network address for the relay to facilitate communicating during handover.

67. An apparatus for handing over a relay and associated user equipment (UE), comprising:
a group handover message receiving component for receiving a grouping of different handover request messages related to a plurality of UEs communicating with a relay from a source donor evolved Node B (eNB); and
a bearer establishing component for establishing one or more bearers for the relay for communicating with the plurality of UEs based on the grouping of different handover request messages.

68. The apparatus of claim 67, wherein the bearer establishing component further generates a grouping of acknowledgement indicators specifying whether bearers for each of the plurality of UEs are established.

69. The apparatus of claim 67, wherein the grouping of different handover request messages includes one or more tunnel endpoint identifiers (TEID) related to the plurality of UEs.

70. The apparatus of claim 69, wherein the bearer establishing component requests, from a mobility management entity related to the relay, a path switch for the one or more TEIDs to the one or more bearers.

71. The apparatus of claim 67, further comprising a data forwarding component for forwarding relay bearer packets received from the source donor eNB to the relay over the one or more bearers before forwarding UE bearer packets received from the source donor eNB to at least one of the plurality of UEs over the one or more bearers.

72. The apparatus of claim 67, further comprising a serving gateway or packet data network gateway function for establishing a temporary network address for the relay to facilitate communicating during handover.

73. A method for handing over a relay, comprising:
receiving a create session request from a mobility management entity of a relay related to one or more bearers at the relay during handover; and
initiating a create session procedure in a target packet data network (PDN) gateway for the one or more bearers based at least in part on receiving the create session request.

74. The method of claim 73, further comprising forwarding data from the target PDN gateway to the relay over the one or more bearers.

75. An apparatus for handing over a relay, comprising:
at least one processor configured to:
receive a create session request from a mobility management entity of a relay related to one or more bearers at the relay during handover; and
initiate a create session procedure in a target packet data network (PDN) gateway for the one or more bearers based at least in part on the create session request; and
a memory coupled to the at least one processor.

76. The apparatus of claim 75, wherein the at least one processor is further configured to forward data from the target PDN gateway to the relay over the one or more bearers.

77. An apparatus for handing over a relay, comprising:
means for receiving a create session request from a mobility management entity of a relay related to one or more bearers at the relay during handover; and
means for initiating a create session procedure in a target packet data network (PDN) gateway for the one or more bearers based at least in part on the create session request.

78. The apparatus of claim 77, wherein the target PDN gateway forwards data to the relay over the one or more bearers.

79. A computer program product for handing over a relay, comprising:
a computer-readable medium, comprising:
code for causing at least one computer to receive a create session request from a mobility management entity of a relay related to one or more bearers at the relay during handover; and
code for causing the at least one computer to initiate a create session procedure in a target packet data network (PDN) gateway for the one or more bearers based at least in part on the create session request.

80. The computer program product of claim 79, wherein the computer-readable medium further comprises code for causing the at least one computer to forward data from the target PDN gateway to the relay over the one or more bearers.

81. An apparatus for handing over a relay, comprising:
a session requesting component for receiving a create session request from a mobility management entity of a relay related to one or more bearers at the relay during handover; and
a session establishing component for initiating a create session procedure in a target packet data network (PDN) gateway for the one or more bearers based at least in part on the create session request.

82. The apparatus of claim 81, wherein the target PDN gateway forwards data to the relay over the one or more bearers.
